(19) United States
(12) Patent Application Publication
(10) Pub. No.: US 2006/0275587 A1
(43) Pub. Date: Dec. 7, 2006

(54) Support for image recording medium, method for making the support and image ecording medium using the support

(76) Inventors: Shigehisa Tamagawa, Shizuoka (JP); Yukio Hirashima, Shizuoka (JP)

Correspondence Address: YOUNG & THOMPSON, 745 SOUTH 23RD STREET, 2ND FLOOR, ARLINGTON, VA, 22202, US

(21) Appl. No.: 11/386,758

(22) Filed: Mar. 23, 2006

(30) Foreign Application Priority Data
Mar. 31, 2005 (JP) 2005-103709

(51) Int. Cl. B32B 27/10; B32B 27/32; B41M 5/00

(52) U.S. Cl. 428/195.1; 428/513; 428/537.5

(57) ABSTRACT

A support for an image recording medium comprises base paper and a polymer coating layer which is formed on both surfaces of the base paper with an obverse side surface (a side for image recording) calendered at a surface temperature between 200 and 350° C. and treated by corona charge treatment at a wattage density between 15 and 150 W/m²/min. The obverse side polymer coating layer contains 50% by mass of polyethylene resin having MFR between 10 and 20 and a density between 0.195 and 0.930.

### BACKGROUND OF THE INVENTION

1. Field of the Invention

The present invention relates to a support for an image recording medium that has high smoothness and distinguished glossiness suitable, a method for making the support, and an image recording medium using the support.

2. Description of Related Art

Typically, a support for an image recording medium used for electrophotographic recording, heat sensitive color recording, sublimation transfer recording, thermal transfer recording, silver halide photographic recording, ink-jet recording, etc. comprises, for example, base paper, artificial or synthetic paper, synthetic resin paper, coated paper, laminated paper, etc. Among these papers, the laminated paper or the coated paper is favorably used. In order to provide high quality, extremely glossy and notably smooth prints, the image recording medium, and hence the support, should have a highly smoothed surface for image recording.

There have been known various methods for making the coated paper and the laminated paper such as, for example, a solvent coating method for coating base paper with a solution of a thermoplastic resin dissolved in an organic solvent, an aqueous coating method for coating base paper with latex or a water solution (varnish) of a thermoplastic resin, a dry lamination method for laminating a thermoplastic resin film onto base paper, a melt extraction coating method, a cast coating method, etc.

However, the solvent coating process has an adverse environmental effect because of a harmful organic solvent contained therein. In addition, the aqueous coating process causes “roughening” of base paper, that is known as such a phenomenon that the base paper looses smoothness due to wetting and swelling of the base paper while the base paper is coated with latex or a water solution and, in addition, is hardly adaptable to resins that are inapt to become latex or to dissolve in water. The cast coating process has an advantage of providing a glossy coated surface without minute irregularities, concavities and convexities, and, however, causes deterioration in smoothness of the coated surface (an occurrence of undulations) if the base paper has a coarse surface which leads to an unsatisfying performance of the support for an image recording medium.

When forming a resin coating layer on base paper, there possibly occurs a large number of small pits or concavities in the resin coating layer. These pits are produced by air trapped between a resin coating layer and a processing roller and crushing the resin coating layer when the base paper has a coarse surface. The presence of a large number of small pits are often conductive to deterioration in surface glossiness of the support. One of known approaches for improvement of smoothness of base paper is to calender a surface of the base paper by a metal roller. For a more complete description of this solution, see Unexamined Japanese Patent Publication Nos. 2003-248336 and 2005-9053.

### SUMMARY OF THE INVENTION

It is therefore an object of the present invention to provide a support for an image recording medium that is superior in smoothness and glossiness and has enhanced adhesion between base paper and a polymer coating layer formed on the base paper and suitably used for various types of image recording mediums.

It is another object of the present invention to provide an image recording medium that is superior in smoothness and glossiness and capable of forming high quality images thereon.

The foregoing subjects of the present invention is accomplished by a support comprising base paper and a polymer coating layer formed on both obverse and reverse side surfaces of the base paper treated by soft calendaring treatment and subsequently by corona discharge treatment at a wattage density in a range of from 15 to 150 W/m²/min. The obverse side surface of the base paper should be calendered at a surface temperature in a range of from 200 to 350° C. The polymer coating layer on at least the obverse side surface of the base paper may contain a polyolefin resin or more than 50% by mass of a polyethylene resin having an MRF in a range of from 10 to 20 and a density in a range of 0.195 to 0.930. It is preferred that the polymer coating layer is formed at a coating speed greater than 250 m/min by a melt extrusion coating machine.

The support is manufactured by a method comprising the steps of treating the obverse side and the reverse side surface of the base paper by soft calendaring treatment; treating the obverse side and the reverse side surface of the base paper by corona discharge treatment at a wattage density in a range of from 15 to 150 W/m²/min, and forming a polymer coating layer on both surfaces of the base paper. The soft calendaring treatment should be performed at a surface temperature in a range of from 200 to 350° C. for the obverse side surface of the base paper.

The support is superior in adhesion between the base paper and the polymer coating layer and is prevented from causing cockles and dents of the base paper and small pits in the polymer coating layer, striking a balance between high smoothness and glossiness. In consequence, the support is favorably used for a wide variety of image recording mediums.

The method for manufacturing the support includes at least calendaring the obverse side surface of the base paper at a surface temperature in a range of from 200 to 350° C. by soft calendaring, treating the obverse side surface of the base paper by corona discharging at a wattage density in a range of from 15 to 150 W/m²/min, and forming a polymer coating layer on both surfaces of the base paper by melt extrusion laminating. This support manufacturing method enables to manufacture the support superior in adhesion between the base paper and the polymer coating layer and striking a balance between high smoothness and glossiness at high productive efficiency and low costs.

The image recording medium using the support and manufactured by the method described above is capable of forming high quality, high glossy and smooth prints.

### BRIEF DESCRIPTION OF THE DRAWINGS

The foregoing and other objects and features of the present invention will be clearly understood from the following detailed description when read with reference to the accompanying drawing, in which:

FIG. 1 is a schematic view of a press shoe calendering machine by way of example;

FIG. 2 is a schematic view of another press shoe calendering machine by way of example;

FIG. 3 is a schematic view of a belt-fixing device used in an image forming machine by way of example;

FIG. 4 is a schematic view of a corona discharging machine used in a support manufacturing method according to an embodiment of the present invention; and

FIG. 5 is a schematic view of coating machine used in a support manufacturing method according to an embodiment of the present invention

### DETAILED DESCRIPTION OF THE PREFERRED EMBODIMENTS

A support for an image recording medium of the present invention comprises base paper and a cast coating layer formed on both surfaces of the base paper, and, if necessary, other layers. The base paper is not bounded by type and may be selected from various paper according to purposes. Preferred examples of the base paper include such quality paper as described in “Fundamentals of Photographic Engineering—Silver halide Photography—,” pages 223 and 224, edited by Japanese Society of Photograph (1979, Corona Co., Ltd.).

Materials for of the base paper is not bounded by type as long as it is used for a support and may be selected from those known in the art according to purposes. Examples of the materials for the base paper include, but not limited to, natural pulp such as coniferous tree pulp or broad leaf tree pulp and mixtures of these natural pulp and synthetic pulp. While it is preferred to use broad leaf tree pulp in terms of improvement of surface flatness and dimensional stability of the base paper together to a sufficient and balanced level, it is feasible to use coniferous tree pulp. Examples of the broad leaf tree pulp include bleached broad leaf tree kraft pulp (LBKP) and broad leaf tree sulfite pulp (LBSP). Among them, bleached broad leaf tree kraft pulp (LBKP) is preferred. The base paper is not bounded by pulp content and, however, contains preferably more than 50% by mass, and more preferably more than 60% by mass and most preferably more than 75% by mass, of broad leaf tree pulp. Examples of the coniferous tree pulp include breached coniferous tree kraf pulp (NBPK). It is preferred to use broad leaf pulp, that is inherently short in fiber length, in major proportions.

The pulp can be beaten to a pulp slurry (which is referred to as pulp stock in some cases) by, for example, a beater or a refiner. It is sensible to add various additives, e.g. a filler, a dry strength intensifying agent, a sizing agent, a wet strength intensifying agent, a fixing agent, a pH adjuster and other chemical conditioners, into the pulp slurry as appropriate.

Examples of the filler include, but not limited to, calcium carbonate, clay, kaolin, white earths, talc, titanium oxides, diatom earths, barium sulfate, aluminum hydroxides, magnesium hydroxides, etc. Examples of the dry strength intensifying agent include, but not limited to, cationic starch, cationic polyacrylamide, anionic polyacrylamide, amphoteric polyacrylamide, carboxy-modified polyvinyl alcohol, etc. Examples of the sizing agent include, but not limited to, fatty acid salts, rosin, rosin derivatives such as maleic rosin, paraffin wax, an alkyl ketene dimer, alkenyl succinic anhydrate; compounds containing higher fatty acids such epoxidized fatty amid, etc. Examples of the wet strength intensifying agent include, but not limited to, polyamine polyamide epichlorohydrin, melamine resins, urea resins, epoxidized polyamide resins, etc. Examples of the fixing agent include, but not limited to, polyvalent metal salts such as aluminum sulfate and aluminum chloride, cationic polymers such as cationic starch, etc. Examples of the pH adjuster include, but not limited to, caustic soda, sodium carbonate, etc. Examples of the other chemical conditioners include, but not limited to, a deforming agent, a dye, a slime controlling agent, a fluorescent whitening agent, etc. In addition, it is allowed to add a softening agent such as described in “New Handbook of Paper Processing,” pages 554 and 555, (1980, Paper Chemicals Times), as appropriate.

The additives and chemical conditioners may be added individually or in any combination of two or more of them. The additive content of the pulp slurry is not bounded and, however, preferably in a range of from 0.1 to 1.0% by mass.

Base paper is made from a pulp stock with one or more additives added therein as appropriate using a manual paper machine, a fourdrinier paper machine, a cylinder paper machine, a twin wire paper machine, a combination paper machine, etc and then dried. If desired, it is sensible to apply surface sizing treatment to the base paper before or after drying.

A processing liquid for use in the surface sizing treatment contains, for example, at least one of alkali metal salts and alkali earth metal salts, a water-soluble polymer compound, a fluorescent whitening agent, a water-resisting material, a pigment, a dye, etc.

Examples of the water-soluble polymer compound include, but not limited to, polyvinyl alcohol, carboxy-modified polyvinyl alcohol, acrboxymethyl cellulose, hydroxyethyl cellulose, cellulose sulfate, polyethylene oxides, gelatin, cationic starches, casein, sodium polyacrylate, styrene-maleic anhydrate copolymer sodium salts, sodium polystrene sulphonate, etc. Among them, it is preferred to use polyvinyl alcohol, carboxy-modified polyvinyl alcohol, acrboxymethyl cellulose, hydroxyethyl cellulose, cellulose sulfate, polyethylene oxides or gelatin, and more preferably polyvinyl alcohol. It is preferred for the surface sizing treatment processing liquid to contain a water-soluble polymer compound in a range of from 0.5 to 2 g/m³.

Examples of the fluorescent whitening agent include, but not limited to, stilbene type compounds, coumarin type compounds, biphenyl type compounds, benzoxazoline type compounds, naphthalimide type compounds, pyrazoline type compounds, carbostyryl type compounds, derivatives of diaminostilben disulfonate, derivatives of imidazole, derivatives of coumarin, derivatives of triazole, derivatives of carbazole, derivatives of pyridine, derivatives of naphthalene acid, derivatives of imidazolone, etc. Among them, it is preferred to use a stilbene compound. It is preferred for the base paper to contain a fluorescent whitening agent in a range of from 0.01 to 0.5% by mass, and more preferably in a range of from 0.02 to 0.2% by mass.

Examples of the water-resisting agent include, but not limited to, latex emulsions of a styrene-butadiene copolymer, a ethylene-vinyl acetate copolymer, polyethylene and a vinylidene chloride copolymer, polyamide polyamine epichlorohydrin; etc.

Examples of the pigments include calcium carbonate, clay, kaolin, talc, barium sulfate, titanium oxides, etc.

It is preferred for the base paper to have a Young's modulus ratio of longitudinal Young's modulus (Ea) to transverse Young's modulus (Eb) in a range of from 1.5 to 2.0 in terms of improved rigidity and dimensional stability of the support. If the upper and lower limits are exceeded, the support for an image recording medium is apt to deteriorate rigidity and/or dimensional stability, resulting in deterioration in transport quality.

Generally, the term “stiffness” of paper varies depending upon different beating forms. Elastic force (elasticity modulus) that paper made after beating attains can be used as a key factor for representing a degree of “stiffness” of paper. In particular, the elastic modulus of paper is found through the use of the relationship between a dynamic elastic modulus and density of paper that shows solid state properties of a visco-elastic body. That is, the elastic modulus of paper is expressed in terms of an acoustic propagation velocity through the paper as below.
E=ρc²(1−n)
where E is the dynamic elasticity modulus of paper;
ρ is the density of paper,
c is the acoustic velocity through paper
n is the Poisson's ratio.
   Because the Poisson's ratio of ordinary paper is approximately 0.2, the dynamic elasticity modulus can be approximated by the following expression:
   E=ρc²
   That is, the elasticity modulus of paper is easily obtained by substituting a density of paper and an acoustic velocity of paper for ρ and c in the above expression, respectively. An acoustic velocity of paper can be measured using a ultrasonic transducer such as, for example, Sonic Tester, Model SST-110 (Nomura Co., Ltd.).

The base paper is not bounded by thickness and may have a thickness preferably in a range of from 30 to 500 μm, more preferably in a range of from 50 to 300 μm, and most preferably in a range of from 100 to 250 μm. The base paper is not bounded by basic weight and may have a basic weight preferably in a range of from 50 to 250 g/m³ and more preferably in a range of from 100 to 200 g/m³.

The polymer coating layer is formed on both surfaces of the base paper. A constitutive polymer for the polymer coating layer is preferred to be film formative. Preferred one of film formative polymers is a polyolefin resin. Preferred examples of the polyolefin resin include, but not limited to, polyethylene, polypropylene, blends of polyethylene and polypropylene, high density polyethylene, blends of high density polyethylene and low density polyethylene, etc. The polymer coating layer is not bounded by process and may be formed by any method known in the art. Examples of available methods include, but not limited to, an ordinary laminating method, a consecutive laminating method, a laminating method using a foot-block type, a multi-manifold type or a multi-slot type of single-layer extrusion die or multi-layer extrusion die, or a laminator. The single-layer extrusion die and the multi-layer extrusion die are not bounded by die shape and is preferred to be a T-die or a coat hanger die.

It is preferred for the polymer coating layer to have a thickness in a range of from 10 to 60 μm and, in particular, in a range of from 10 to 50 μm for a reverse side surface of the base paper.

The polymer coating layer for an obverse side surface of the base paper (a surface on which an image is formed) should contain more than 50% by mass of polyethylene resin having a melt flow rate (MFR) in a range of from 10 to 20 and a density in a range of from 0.195 to 0.930 for providing the support that is superior in surface quality and adhesion to the base paper and has no pit. The polymer coating layer possibly deteriorates adhesion to the base paper if the polyethylene resin content is less than 50% by mass, if the MFR is less than 10, or if the density is too high beyond 0.930. Further, the polymer coating layer possibly deteriorates film stability during extrusion coating If the MFR exceeds 20.

The support described above is superior in adhesion between the base paper and the polymer coating layer, and have high flatness and smoothness and distinguished glossyness and, in consequently, suitably used for an image recording medium available for electrophotographic recording, heat sensitive color recording, sublimation transfer recording, thermal transfer recording, silver halide photographic recording, ink-jet recording, etc.

The method for making the support for an image recording medium includes at least the steps of calendering the base paper and a forming the polymer coating layer and, if necessary, other steps. The calendaring is a process of calendering an obverse side surface of the base paper by bringing it into contact with a roller at a surface temperature preferably in a range of from 200 to 350° C., and more preferably in a range of from 220 to 300° C. If the surface temperature of the roller is beyond the permissible compass of surface temperature, the calendering works insufficiently on the base paper. Specifically, the base paper encounters deterioration in surface flatness and smoothness, and besides in glossiness, if the surface temperature of is less than 200° C., and possibly causes rumples and dishes, and besides aggravation of adhesion to the polymer layer due to an increase in density, if beyond 350° C. The calendering is not bounded by nip pressure and is preferably performed at a nip pressure higher than 100 kN/cm², and more preferably in a range of from 100 to 600 kN/cm².

The calender roller is not bounded by type and may be of a known type. Examples of the calender roller include, but not lomited to, soft calendering machines comprising a combination of a metal roller and a plastic roller, and mechanical calendering machines comprising a pair of metal rollers. Among them, it is preferred to employ a soft calendering machine. It is especially preferred to employ a long nip type of press shoe calendering machine comprising a metal roller and a press shoe in contact with the metal roller through a plastic belt in terms of availability of a long nip which provides an increased contact length between the calendaring roller and the base paper. The press shoe calendering machine is equipped with an elastic endless belt and other parts as appropriate. The term “endless belt” as used herein shall include cylindrical sleeves, besides endless belts of general idea. The press shoe calendering machine is equipped with a pressure unit and a lubricant circulatory system in addition to the endless belt or a cylindrical sleeve.

The elastic endless belt comprises a thick cloth of core belt and an elastic resinous sheath made of, for example, an epoxy resin, a polyamide resin, a polyimide resin, a polyimideamide resin, a polyurethane resin, a butadiene resin, a polyester resin, a nylon resin, a polyether resin or the like. These resin may be selectively used individually or in any combination of two or more of them. It is preferred for the endless belt or the sleeve to have a Shore harness in a range of from 30 to 80 degrees, and more preferably in a range of from 40 to 70 degrees. The endless belt experiences elastic deformations which shortens a service life of the press shoe, and besides it is apt to fail to provide the base paper having high flatness and smoothness and glossiness, if the Shore hardness is less than 30 degrees, and the endless belt is possibly too unyielding to fit a curved surface of the press shoe if beyond 80 degrees. The metal roller in cooperation with the press shoe is not bounded by material and may take any metal roll known in the art as long as it has a smooth cylindrical surface, solid or hollow, and is equipped with heating means incorporated therein. Since the metal roller is brought into contact directly with the obverse side surface of the base paper, it is preferred for the metal roller to have a surface as smooth as possible. More specifically, the surface roughness is preferably less than 0.3 S and more preferably less than 0.2 S as measured in the method meeting JIS B0601. In the case where the base paper contains a water-soluble metallic salt, it is general to use a chromeplated metal roller for rustproof. A chromiumplated layer is generally too poor in high-temperature resistance to be in no risk of cracking during use at a temperature in that temperature range. In terms of cracking protection, it is preferred to apply surface treatment such as cermet thermal splaying or ceramic thermal splaying to the metal roller. Examples of thermal splaying material include tungsten carbide-cobalt thermal splaying, tungsten carbide-nickel thermal splaying, etc. for the cermet thermal splaying and chromium oxides, zirconium oxides, etc. for the ceramic thermal splaying. These surface treatment provides the metal roller with a rustproof property and enhanced high-temperature resistance, and besides, distinguished an anti-cracking property and improved durability.

It is preferred to perform the press shoe carendering machine having a nip length between the metal roller and the press shoe in a range of from 50 to 300 mm, more preferably in a range of from 50 to 200 mm, and most preferably in a range of from 70 to 200 mm. If the nip length is less than 50 mm, the calendering does not much effect on the base paper because of too short contact time of the metal roller with the base paper. On the other hand, if the nip length is beyond 300 mm, the calendering does not much effect on the base paper because of low line contact pressure. Further, it is preferred to perform the calendaring at a base paper feed speed in a range of from 100 to 800 mm/min, more preferably in a range of from 150 to 600 mm/min, and most preferably in a range of from 200 to 800 mm/min. The base paper decreases its productivity if the feed speed is less than 100 mm/min and is calendered ineffectively if beyond 800 mm/min.

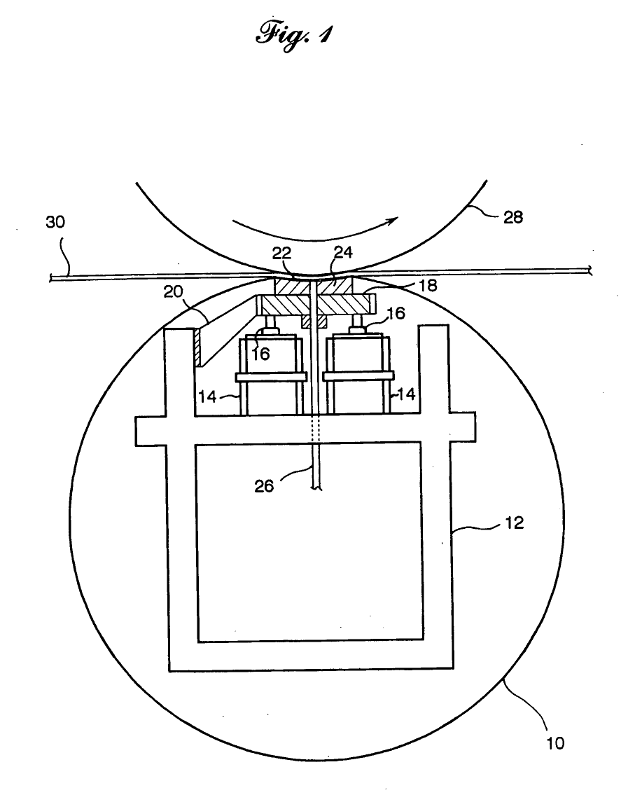

For the purpose of providing a description about a calendering machine offered by way of example, reference is made to FIGS. 1 and 4.

FIG. 1 shows an example of press shoe calendering machine equipped with an impermeable flexible endless belt 10 made of an elastic resin that is formed in a circle. The press shoe calendering machine comprises a substructure 12 disposed within the circular endless belt 10, a palir of hydraulic power systems 14 having piston rods 16 secured as pressure units to the substructure 12, a supporting plate 18 secured to the piston rods 16 and supported for up and down slide movement by the substructure 12 through an arm 20 as an integral piece of the supporting plate 18, a press shoe 24 having a curved top surface 22 fixedly supported on the supporting plate 18, and a metal roll 28. The press shoe calendering machine is further equipped with a lubricant supplying system schematically denoted by a reference numeral 26 to supply a lubricant to the curves top surface 22 of the press shoe 24.

A base paper web 30 sandwiched between press felt wrappers (not shown) is fed into a nip between the press shoe 24 and the metal roll 28. When rotating the metal roll 28 in a direction shown by an arrow, the hydraulic power units 14 force the piston rods 16 upward to press the base paper web 30 against the metal roll 28 at a predetermined pressure and, at this time, the lubricant supplying system 26 supplies a lubricant onto the curved surface 22 of the press shoe 24, In this calendering process, the base paper web 28 is adjusted to a predetermined density while moisture contained in the base paper is absorbed by the press felt wrappers.

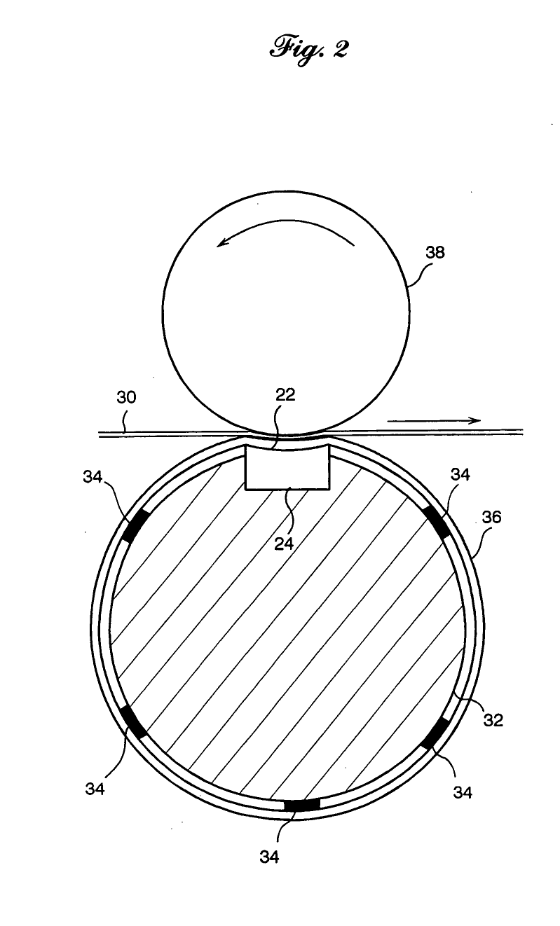

FIG. 2 shows another example of press shoe calendering machine in which parts or mechanisms that are the same as those of the press shoe calendering machine shown in FIG. 1 are denoted by the same reference numerals as used in FIG. 1 and not described in detail. As shown in FIG. 2, the press shoe calendering machine is equipped with a cylindrical substructure 32 in which a hydraulic power system as a pressure unit and a lubricant circulatory system (both of which are not shown) are incorporated. The cylindrical substructure 32 is provided with guide pads 34 for guiding rotation of a cylindrical sleeve 36. In the case where the guide pads 34 keeps the cylindrical sleeve 36 away from the cylindrical substructure 32, the base paper web 30 can release frictional heat generating when passing through between the press shoe 24 and the metal roller 28, so as to allow high speed operation of the shoe calender machine and make a service life of the sleeve 36. Further, it is also suitable to supply a cold lubricant oil into a space between the substructure 32 and the sleeve 36 in order to enhance an heat releasing effect.

The polymer coating process is performed within one minute after application of corona discharging treatment to the calendered base paper. The corona discharge is performed at a wattage density in a range of from 15 to 150 W/m²/min. While the base paper encounters some what considerable deterioration in adhesion due to the flatness and smoothness improved by the carendering treatment, neverseless, as a result of application of the corona discharge treatment, the base paper is modified in surface texture quality and, consequentially, improved in adhesion to the polymer layer. The base paper is modified insufficiently in surface texture quality if the wattage density is less that 15 W/m²/min and is not always expected to be further blessed with improvement in adhesion even if beyond 150 W/m²/min. The polymer coating layer should be formed on the base paper before the effect of surface texture quality modification has worn off in order to preserve good adhesion of the base paper.

As was described previously, it is preferred to coat the base paper with a polyethylene resin layer for the polymer coating layer by melt extrusion lamination. The melt extrusion lamination of the polyethylene coating layer is performed at a coating speed higher than 250 m/min using a melt extrusion coating machine. Since the base paper is improved in adhesion by the corona discharge treatment, the polyethylene resin layer is well adhered to the base paper even when coated at a speed higher than 250 m/min. This increases the productivity of support.

According to the method for making the support as described above, the support having distinguished adhesion between the base paper and the polymer coating layer, high surface flatness and smoothness and distinguished surface glossiness is made at high productive efficiency and low costs.

An image recording medium of the present invention comprises the support described above and an image recording layer, and other layers as appropriate, formed on the support. The image recording medium may be different according to applications and types such as electrophotographic recording, heat sensitive color recording, sublimation transfer recording, thermal transfer recording, silver halide photographic recording, ink-jet recording, etc.

The electrophotographic recording medium, taking the form of paper, comprises the paper support and at least one toner receptor layer formed as an image recording layer on at least one of obverse and reverse side surfaces of the paper support. It is sensible to form one or more layers appropriately selected from a surface protective layer, a backing layer, an intermediate layer, an under coating layer, a cushioning layer, an electrostatic charge control or antistatic layer, a reflection layer, a color tincture adjusting layer, a storage stability improving layer, an anti-adhesion layer, an anti-curling layer and a smoothing layer, as appropriate. These layer may be single layered or multi layered.

The toner receptor layer receives a toner image from a development drum or an intermediate transfer member by means of (static) electricity or pressure during a toner image transfer process and is solidified by heat or pressure in a toner image fixing process. The toner receptor layer is preferably low in transparency and, more specifically, less than 78%, more preferably less than 73% and most preferably less than 72%, in optical transmissivity in light of visual impression like a photographic print. The optical transmissivity can be found by, for example, measuring an optical transmissivity of a same thickness of sample toner receptor layer formed on a polyethylene terephthalate film 100 μm thick on a direct reading Hayes meter, for example Model HGM-2DP: (Suga Testing Machine Co., Ltd.).

The toner receptor layer contains at least a thermoplastic resin and, if necessary , various additives such as a releasing agent, a plasticizing agent, a coloring agent, a filler, a cross-linking agent, an electrostatic charge control agent, an emulsifying agent and dispersant, for the purpose of improving thermo-dynamic properties of the toner receptor layer. Examples of the thermoplastic resin for the toner receptor layer include, but not limited to, (1) polyoleflin resins, (2) polystyrene resins, (3) acrylic resins, (4) polyvinyl acetate or derivatives of them, (5) polyamide resins, (6) polyester resins, (7) polycarbonate resins, (8) polyether resins or acetal resins, and (9) other resins. Among them, it is preferred to employ acrylic resins, polyvinyl acetate or polyester resins which are high in cohesive energy, in terms of toner burying. These thermoplastic resins may be selectively used individually or in any combination of two or more of them.

Examples of (1) the polyolefin type resins include, but not limited to, polyolefin resins such as polyethylene and polypropylene; olefin copolymer resins such as ethylene or propylene polymerized with another vinyl monomer, etc. Examples of the copolymer rein of the olefin and another vinyl monomer include ethylene-vinyl acetate copolymers; and ionomer resins that are copolymers polymerized with an acrylic acid or a methacrylic acid. In this instance, examples of the derivative of a polyolefin resin include chlorinated polyethylene and chlorosulfonated polyethylene.

Examples of (2) the polystyrene type resins include, but not limited to, polystyrene resins, styrene-isobutylene copolymers, styrene-isobutylene copolymers, aclylonitrile-styrene copolymers (AS resins), acrylonitrile-butadiene-styrene copolymers (ABS resins), polystyrene-maleic anhydride resins, etc.

Examples of (3) the acryl type resins include, but not limited to, a polyacrylic acid or their ester, polymethacrylic acids or their ester, polyacrylonitrile, polyacrylamide, etc. Examples of the ester of polyacrylic acid include homopolymers or multiple copolymers of ester of acrylic acid, etc. Example of the ester of acrylic acid include methyl acrylate, ethyl acrylate, n-butyl acrylate, isobutyl acrylate, doecyl acrylate, n-octyl acrylate, 2-ethylhexyl acrylate, 2-chrolethyl acrylate, phenyl acrylate, α-chlor methyl acrylate, etc. Examples of the ester of polymethacrylic acid include homopolymers or multiple copolymers of ester of methacrylic acid, etc. Examples of the ester of a methacrylic acid include methyl acrylate, ethyl acrylate, butyl acrylate, etc.

Examples of (4) the polyvinyl acetate or its derivative include polyvinyl acetate, polyvinyl alcohol derived by saponifying polyvinyl acetate, polyvinyl acetal resins derived by reacting polyvinyl alcohol with aldehyde (e.g. formaldehyde, acetaldehyde, butylaldehyde, etc.), etc.

Examples of (5) the polyamide type resins, that are polycondensation products of diamine and diacid base, include 6-nylon, 6,6-nylon, etc.

Examples of (6) the polyester resin can be produced by condensation polymerization of an acid component and alcohol. Examples of the acid composition include, but not limited to, a maleic acid, a fumaric acid, a citraconic acid, an itaconic asid, a glutaconic asid, a phthalic acid, a terephthalic acid, an iso-phthalic acid, a succinic acid, an adipic acid, a cebacis acid, an azelaic acids, malonic acids, n-dodecenylsuccinate, iso-dodecenylsuccinate, n-dodecyl-succinate, isododecylsuccinate, n-octenylsuccinate, n-octylsuccinate, iso-octenylsuccinate, iso-octylsuccinate, a triimllitic acid, a pyromellitic acid, anhydride of these acids, lower alkyl ester of these acids, etc. The alcohol component is preferably dihydric. Examples of aliphatic diol include, for example, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, polytetremethylene glycol, etc. Examples of bisphenol A with an adduct of alkylene oxide include, for example, polyoxypropylene (2.2)-2,2-bis (4-hydroxyphenyl) propane, polyoxypropylene (3.3)2, 2-bis(4-hydroxyphenyl) propane, poly-oxyethylene (2.0)2,2-bis(4-hydroxyphenyl) propane, polyoxypropylene(2.0)-polyoxyethylene (2,0)-2,2-bis (4-hydroxyphenyl) propane, polyoxypropylene(6)-2,2-bis(4-hydroxyphenyl) propane, etc.

Examples of (7) the polycarbonate resins include, for example, polycarbonic acid ester derived from bisphenol A and phosgene, etc.

Examples of the polyether resins or acetal resins include, for example, polyether resins such as polyethylene oxides, polypropylene oxides, etc.; acetal resins such as poly-oxymethylene, etc. which are of a ring opening polymerization type.

Examples of (9) the other resins include a polyaddition type polyurethane resins.

In this instance, it is preferred that each thermoplastic resin enables a toner receptor layer to satisfy solid state properties required for the toner receptor layer after formation, and more preferred that the thermoplastic resin itself satisfies the solid state properties of the toner receptor layer. It is also preferred to use two or more thermoplastic resins satisfying different solid state properties required for the toner receptor layer, respectively.

It is preferred for the thermoplastic resin to have a molecular weight greater than a molecular weight of a thermoplastic resin used for a toner. However, this requirement is not always desirable according to relations between thermodynamic characteristics of thermoplastic resins used for the toner receptor layer and the toner. Taking an instance, in the case where the thermoplastic resin for the toner receptor layer has a softening temperature higher than the thermoplastic resin for the toner, it is preferred in some cases that the thermoplastic resin for the toner receptor layer has a molecular weight equal to or less than the thermoplastic resin for the toner.

It is preferred to use a mixture of different thermoplastic resins identical in composition but different in average molecular weight from each other for the toner receptor layer. For a more complete description of the relation to molecular weight of the thermoplastic resin used for toners, see Unexamined Japanese Patent Publication No. 8-334915. It is further preferred for the thermoplastic resin for the toner receptor layer to have a molecular weight distribution wider than that of a thermoplastic resin used for a toner.

It is preferred for the thermoplastic resin to satisfy solid state properties described in, for example, Unexamined Japanese Patent Publication Nos. 5-127413, 8-194394, 8-334915, 8-334916, 9-171265 and 10-221877.

The thermoplastic resin for the toner image receptor layer is preferably of an aqueous type resins such as a water-dispersant resins and a water-soluble resin for the following reasons (i) and (ii):

(i) The aqueous type resins do not discharge organic solvents in a coating and drying process and, in consequence, excels at environmental adaptability and workability,

(ii) A release agent such as wax are hardly soluble in water at an ambient temperature in many instances and is often dispersed in a solvent such as water or an organic solvent prior to use. The water-dispersant type resin is stable and has a superb adaptability to manufacturing process. In addition, aqueous coating causes wax to easily bleed onto a surface of the toner receptor layer during a coating and drying process, so as thereby to bring out effects of the release agent such as an anti-offset property, anti-adhesion property, etc.).

The aqueous type resin is not always bounded by composition, bond-structure, molecular geometry, molecular weight, molecular weight distribution, etc., inasmuch as it is water-soluble or water-dispersant. Examples of a group for turning the polymer into hydrophilic include, or example, a sulfonic acid group, a hydroxyl group, a carboxylic acid group, an amino group, an amid group, an ether group, etc.

Examples of the water-dispersant polymers include water dispersions, elulsions, copolymers, cation modified maters of the resins categorized into (1) to (9). These water-dispersant polymers may be used individually or in any combination of two or more. The water-dispersant polymer may be synthetized or commercially available product. Examples of commercially available water-dispersant polymer include, for example, Vyronal series polymers (Toyobo Co., Ltd.), Pesuresin A series polymers (Takamatsu Oil & Fats Co., Ltd.), Tafuton UE series polymers (Kao Co., Ltd.), Polyester WR series polymers (Nippon Synthetic Chemical Industry Co., Ltd.), and Elietel series polymers (Unitika Ltd.), all of which are of a polyester type, and Hyros XE series polymers, Hyros E series polymers and Hyros E series polymers (Seiko Chemical Industry Co., Ltd.) and Jurimar T series polymer (Nippon Fine Chemical Co., Ltd.), all of which are of an acrylic type.

The water-dispersant emulsion is not bounded by type. Examples of the water-dispersant emulsions include water-dispersant polyurethane emulsions, water-dispersant polyester emulsions, chloroprene type emulsions, styrene-butadiene type emulsions, nitrile-butadiene type emulsions, butadiene type emulsions, vinyl-chloride type emulsions, vinylpyridine-styrene-butadiene type emulsions, polybutene type emulsions, polyethylene type emulsions, vinyl acetate type emulsions, ethylene-vinyl acetate type emulsions vinylidene chloride type emulsions, methylmethacrylate-butadiene type emulsions, etc. Among them, the water-dispersant polyester emulsions are especially preferred The water-dispersant polyester emulsion is preferred to be a self-dispersant type of aqueous polyester emulsion, and especially to preferred be a carboxylic self-dispersant aqueous polyester emulsion. In this instance, the self-dispersant aqueous polyester emulsion as used herein shall mean and refer to an aqueous emulsion containing a polyester resin capable of self-dispersing in an aqueous solvent without the aid of an emulsifier or the like, and the carboxylic self-dispersant aqueous polyester resin emulsion as used herein shall mean and refer to an aqueous emulsion containing a polyester resin that contains a carboxyl group as a hydrophilic group and is capable of self-dispersing in an aqueous solvent.

It is preferred for the self-dispersant type water-dispersant polyester emulsion to satisfy the following properties (1) to (4). This is because, since the emulsions that satisfying the specified properties (1) to (4) are of a self-dispersant type containing no surface active agent, they are low in hydroscopic property even in a humid atmosphere, shows a small drop in softening point due to moisture, and is restrained from causing offset during fixation and adhesion defects between electrophotogreaphic paper during storage. In addition, because of an aqueous type, the emulsions excel at environmental adaptability and workability. Furthermore, because the emulsions contain a polyester resin that is apt to take a molecular geometry having high cohesive energy, they take a low elastic or low viscous molten state in a fixing process of an electrophotography while keeping sufficient hardness in a storage environment. This causes toner particles dig into the toner receptor layer, thereby achieving sufficiently high image quality.

(1) Number-average molecular weight (Mn): preferably in a range of from 5,000 to 10,000, and more preferably in a range of from 5,000 to 7,000

(2) Molecular weight distribution (weight-average molecular weight/number-average molecular weight): preferably less than 4, more preferably equal to or less than 3

(3) Glass transition temperature (Tg): preferably in a range of from 40 to 100° C., and more preferably in a range of from 50 to 80° C.

(4) Volume-average grain size: preferably in a range of from 20 to 200 nm, and more preferably in a range of from 40 to 150 nm

It is preferred that the toner receptor layer contains the water-dispersant emulsion in a range of from 10 to 90% by mass, and more preferably in a range of from 10 to 70% by mass.

The water-soluble polymers are not bounded by weight-average molecular weight as long as less than 400,000 and may be synthesized as appropriate or commercially procured. Examples of the water-soluble polymers include, but not limited to, polyvinyl alcohol, carboxy-modified polyvinyl alcohol, carboxymethyl cellulose, hydroxyethyl cellulose, cellulose sulfate, polyethylene oxides, gelatin, cationized starch, casein, sodium polyacrylate, styrene-maleic anhydride copolymers, sodium polystyrene sulfonate. Among them, it is preferred to use polyethylene oxides. Commercially available examples of the water-soluble polymers include, but not limited to, Pluscoat series water-soluble polyester (Gao Chemical Industry Co., Ltd.), Fintex ES series water-soluble polyester (Dainippon Ink & Chemical Inc.); Jurimar AT series water-soluble acryl (Nippon Fine Chemical Co., Ltd.), Fintex 6161 and Fintex K-96 series water-soluble acryl (Dainippon Ink & Chemical Inc.), and Hyros NL-1189 and Hyros BH-997L series water-soluble acryl (Seiko Chemical Industry Co., Ltd.). In addition, those disclosed in Research Disclosure No. 17,643, page 26; No. 18,716, page 651; No. 307,105, pages 873-874; and Japanese Unexamined Patent Publication No. 64-13546, pages 71-75 are available examples of the water-soluble polymers.

It is preferred for the toner receptor layer to contain a water-soluble polymer content in, but not limited to, a range of from 0.5 to 2 g/m².

The thermoplastic resin may be used in combination with another polymeric material and, in this case, should be higher in content than the other. The toner receptor layer contains the thermoplastic resin preferably greater than 10% by mass, more preferably greater than 30% by mass, and especially preferably in a range of from 50 to 90% by mass.

The release agent is blended in the toner receptor layer in order to prevent an occurrence of offsets. The releasing agent is not bounded by type as long as it is capable of melt at a fixing temperature to separated out and unevenly distribute on a surface of the toner receptor layer, and of solidifying by cooling. The release agent may be one of silicone compounds, fluorine compounds, wax and matting agents. Examples of the release agent include wax such as described in “Revised Edition: Property and Application of Wax” (Koushobou); silicone compounds such as described in “Handbook of Silicon” (Nikkan Kogyo Shinbun); and silicone compounds, fluorine compounds and wax suitably used for toner such as descnbed in Japanese Patent Nos. 2,838,498 and 2,949,558; Japanese Patent Publication Nos. 59-38581 and 4-32380; Japanese Unexamined Patent Publication Nos. 50-117433, 52-52640, 57-148755, 61-62056, 61-62057, 61-118760, 2-42451, 3-41465, 4-212175, 4-214570, 4-263267, 5-34966, 5-119514, 6-59502, 6-161150, 6-175396, 6-219040, 6-230600, 6-295093, 7-36210, 7-43940 7-56387, 7-56390, 7-64335, 7-199681, 7-223362, 7-287413, 8-184992, 8-227180, 8-248671, 8-2487799, 8-248801, 8-278663, 9-152739, 9-160278, 9-185181, 9-319139, 9-319413, 10-20549, 10-48889, 10-198069, 10-207116, 11-2917, 11-449669, 11-65156, 11-73049 and 11-194542. These compounds may be used individually or in combination of two or more.

Examples of the silicone compounds include, for example, silicone oil, silicon rubber, silicon particulates, silicon-modified resins, reactive silicone compounds, etc.

Examples of the silicone oil include, but not limited to, non-modified silicone oil, amino-modified silicone oil, carboxy-modified silicone oil, carbinol-modified silicone oil, vinyl-modified silicone oil, epoxy-modified silicone oil, polyether-modified silicone oil, silanol-modified silicone oil, methacryl-modified silicone oil, mercapto-modified silicone oil, alcohol-modified silicone oil, alkyl-modified silicone oil and fluorine-modified silicone oil.

Examples of the silicon-modified resins include, but not limited to, olefin resins, polyester resins, vinyl resins, polyamide resins, cellulose resins, phenoxy resins, vinyl chloride-vinyl acetate resins, urethane reins, acryl resins, styrene-acryl resins, and resins made produced by silicon-modifying copolymers of them.

Examples of the fluorine compounds include, but not limited to, fluorine oil, fluoro rubber, fluorine-modified resins, fluorosulfonic acids, fluorosulfonic compounds, fluorine compounds, salts of fluorine acids, inorganic fluorinated substances.

The wax are broadly classified into two categories, namely natural wax and synthetic wax. It is preferred to select the natural wax from a group of vegetable wax, animal wax, mineral wax, and paraffin wax. Among them, vegetable wax is most preferably used. The natural wax is preferred to be of a water-dispersant type in terms of compatibility in the case where an aqueous resin is used for the toner receptor layer.

The vegetable wax is not bounded by type and may be synthesized or of a commercially available product. Examples of the vegetable wax include carnauba wax, castor oil colza oil, soybean oil, sumac wax, cotton wax, rice wax, sugarcane wax, canderyla wax, Japan wax, jojoba oil, etc. Examples of commercially available carnauba wax include EMUSTAR-0413 wax (Ito Oil Manufacturing Co., Ltd.), Serozole 524 wax (Chukyo Oil & Fats Co., Ltd.) and the like. Examples of commercially available castor oil include refined castor oil (Ito Oil Manufacturing Co.). The carnauba wax having a melt temperature in a range of from 70° C. to 95° C. is especially preferred among them in terms of preeminence in anti-offset property, anti-adhesion property, transport quality, feeling of glossiness, toughness against cracks of the electrophotographic recording medium as well as high image quality.

Examples of the animal wax include, but not limited to, bees wax, lanolin, spennaceti wax, blubber wax (whale oil), wool wax, etc.

The mineral wax is not bounded by type and may be synthesized or of a commertially available product Examples of the mineral wax include, but not limited to, montan wax, montan type ester wax, ozokerite, ceresin, etc. The montan wax having a melt temperature in a range of from 70° C. to 95° C. is especially preferred among them in terms of preeminence in anti-offset property, anti-adhesion property, transport quality, feeling of glossiness and toughness against cracks of the electrophotographic recording medium as well as high image quality.

The paraffin wax is not bounded by type and may be synthesized or of a commertially available product. Examples of the paraffin wax include, but not limited to, paraffine wax, microcrystalline wax, petrolatum, etc.

The natural wax content of the toner receptor layer is preferably in a range of from 0.1 to 4 g/m², and more preferably in a range of from 0.2 to 2 g/m². If the natal wax content is less than 0.1 g/m², significant deterioration in anti-offset property and anti-adhesion property is possibly caused. On the other hand, if the natural wax content is greater than 4 g/m², the amount of wax is too much to ensure a high image quality. Further, the melt temperature of the natural wax is preferably in a range of from 70 to 95° C., and more preferably in a range of from 75 to 90° C. in terms of, in particular, anti-offset property and transport quality.

The synthetic wax is classified into several types, namely synthetic carbon hydride, modified wax, hydrogenated wax, and other fat and oil type synthetic wax. The wax is preferred to be of a water-dispersant type in terms of compatibility in the case where an aqueous resin is used for the toner receptor layer. Examples of the synthetic carbon hydride include Fischer-Tropsch wax, polyethylene wax, etc. Examples of the fat and oil type synthetic wax include acid amide compounds such as amid stearate, acid imide compounds such as phthalic anhydride imide, etc. Examples of the modified wax include, but not limited to, amine-modified wax, acrylate modified wax, fluorine modified wax, olefin modified wax, urethane type wax and alcohol type wax. Examples of the hydrogenated wax include, but not limited to, cured castor oil, derivatives of castor oil, stearic acids, lauric acids, myristic acids, palmotic acids, behenic acids, sebacic acids, undecylic acids, heptyl acids, maleic acids, high maleic oil, etc.

The melt temperature of the release agent is preferably in a range of from 70 to 95° C., and more preferably in a range of from 75 to 90° C. in terms of, in particular, anti-offset property and transport quality. The release agent used for the toner receptor layer may be derivatives, oxides, or refined products of the substances described above which may have reactive substituents. The release agent content is preferably in a range of from 0.1 to 10% by pass, and more preferably in a range of from 0.3 to 8.0% by mass, and most preferably in a range of from 0.5 to 5.0% by mass relative to the mass of the toner receptor layer. If the release agent content is less than 0.1% by mass, significant deterioration in anti-offset property and anti-adhesion property is possibly caused. On the other hand, if the natural wax content is greater than 10% by mass, the amount of wax is too much to ensure image quality.

The plasticizing agent, that has the function of controlling fluidization or softening of the toner receptor layer by heat and/or pressure in a toner fixing process, is not bounded by type. The plasticizing agent can be selected consulting “Handbook Of Chemistry” (Chemical Society of Japan; Maruzen), “Plasticizer—Theory and Applications—” (Kouichi Murai; Koushobou), “Study On Plasticizer Vol. 1” and “Study On Plasticizer Vol. 2” (Polymer Chemistry Association), or “Handbook Rubber·Plastics Compounding Chemicals” Rubber Digest Ltd.), etc.

Examples of the plasticizing agents include, for example, compounds such as ester (e.g. phthalate ester, phosphate ester, fatty ester, abietate, adipate, sebacate, azelate, benzoate, butyrate, epoxidized fatty ester, glycolate, propionate, trimellitate, citrate, sulfonate, calboxylate, succinate, maleate, phthalate, stearate, etc.); amide (e.g. fatty amide, sulfonamide, etc.); ether, alcohol; lactone; and polyethyleneoxy, which are cited as high boiling point organic solvents and thermal solvents in, for example, Japanese Unexamined Patent Publication Nos. 59-83154, 59-178451, 59-178453, 59-178454, 59-178455, 59-178457, 62-174745, 62-245253, 61-09444, 61-2000538, 62-8145, 62-9348, 62-30247, 62-136646, and 2-235694.

Polymers having comparatively low molecular weights may be used as the plasticizing agent. Such a polymer is preferably lower in molecular weight than a binder resin that is to be plasticized, more specifically, less than 15000 and most preferably less than 5000. In the case of using a polymer for the plasticizing agent, it is preferred for the polymer to be of the same type as a binder resin that is to be plasticized. For example, when plasticizing a polyester resin, it is preferred to use a polyester of low molecular weight. Also, oligomer may be used for the plasticizing agent. In addition to the above mentioned compounds, there are various commercially available plastiizing agents, examples of which include Adecasier PN-170 and Adecasizer PN-1430 (Asahi Denka Kogyo K.K.); PARAPLEX-G-25, PARAPLEX-G-30 and PARAPLEX-G-40 (HALL Corporation); and Estergun 8L-JA, Ester R-95, Pentaryn 4851, Pentaryn FK115, Pentaryn FK4820, Pentaryn FK830, Ruizol 28-JA, Picorastic A75, Picotex LC and Crystalex 3085 (Rika Hercules Co., Ltd.); etc.

The plasticizing agents may be optionally used in order to reduce stress or stain (physical strain of elastic force and/or viscosity, and strain due to mass balance of molecules, main chains and pendants) that occurs in toner particles when the toner particles are buried in the toner receptor layer. The plasticizing agent may be present in the toner receptor layer in a microscopically dispersed state, in a microscopically phase-separated state like a sea-island state, or in a state where the plasticizing agent has mixed with and dissolved in other components such as a binder sufficiently. It is preferred for the toner receptor layer to contain a plasticizing agent in a range of from 0.001% to 90% by mass, more preferably in a range of from 0.1 to 60% by mass, and most preferably in a range of from 1 to 40% by mass. The plasticizing agent may be utilized for the purpose of adjusting a gliding property (improving transport quality due to a reduction in frictional force), improving an offset property at a fixing device (separation of a toner and a toner layer to the fixing device), adjusting a curling balance and controlling static build-up (formation of electrostatic toner image).

Examples of the coloring agent include, but not limited to, fluorescent whitening agents, white pigments, colored pigments, dye, etc. The fluorescent whitening agent is not bounded by type as long as having an absorption feature in a near-ultraviolet range and generating fluorescence in a range of from 400 to 500 nm. Preferred examples of the fluorescent whitening agents include compounds such as disclosed in “The Chemistry of Synthetic Dyes” by K. VeenRatarman Vol. 8, Chapter 8. Specifically, the compounds may be synthesized or of commercially available products, example of which include stilbene compounds, coumarin compounds, biphenyl compounds, benzooxazoline compounds, naphthalimide compounds, pylazorine compounds, carbostyryl compounds, etc.; and, as commercially available fluorescent whitening agent, White Fulfa PSN, White Fulfa PHR, White Fulfa HCS, White Fulfa PCS and White Fulfa B (Sumitomo Chemical Co., Ltd.), and UVITEX-OB (Chiba-Geigy Ltd.).

Example of the white pigments include, but not limited to, inorganic pigments such as a titanium oxide, calcium carbonate, etc.

Examples of the colored pigments include, but not limited to, various pigments described in, for example, Japanese Unexamined Patent Publication No. 63-44653, azo pigments, polycyclic pigments, condensation polycyclic pigments, lake pigments, carbon black, etc. Examples of the azoic pigments include azolake pigment such as carmine 6B and red 2B; insoluble azo pigments such as monoazo yellow, disazo yellow, pyrazolo orange and Balkan orange; condensation azoic pigments such as chromophthal yellow and chiomophthal red; etc. Examples of the polycyclic pigments include phthalocyanine pigments such as copper phthalocyanine blue, copper phthalocyanine green, etc. Examples of the condensation polycyclic pigments include dioxazin pigments such as dioxazin violet, isoindorinon pigments such as isoindolynon yellow, slene pigments, perylene pigments, perynon pigments, thioindigo pigments, etc. Examples of the lake pigments include malachite green, rhodamine B, rhodamine G, Victoria blue B, etc. Examples of the inorganic pigments include oxides such as a titanium dioxide, colcothar, etc.; sulfate such as precipitated barium sulfate; carbonate such as precipitated calcium carbonate; silicate such as hydrated silicate, anhydrous silicate, etc.; metal powder such as aluminum powder, bronze powder, blue powder, chrom yellow, iron blue, etc. These pigments may be used individually or in any combination of two or more.

Examples of the dye include, but not limited to, anthraquinone compounds, azoic compounds, etc. These dyes may be used individually or in any combination of two or more.

Examples of water-insoluble dyes include vat dyes such as C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20 and C.I.Vat blue 35; dispersed dyes such as C.I. disperse violet 1, C.I. disperse violet 4, C.I. disperse violet 10, C.I. disperse blue 3, C.I. disperse blue 7 and C.I. disperse blue 58; and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25 and C.I. solvent blue 55; etc. Colored couplers used for silver photography can be preferably utilized.

The coloring agent content of the toner receptor layer is preferably in a range of from 0.1 to 8 g/cm², and more preferably in a range of from 0.5 to 5 g/cm². If the coloring agent content is less than 0.1 g/cm², the toner receptor layer is apt to have a possibly increased optical transmittance. On the other hand, if the coloring agent content is greater than 8 g/cm, the toner receptor layer is apt to become poor in tractability resulting from deterioration in anti-adhesion property and an occurrence of cracks. In particular, the pigment content of the toner receptor layer is preferably less than 40% by mass, more preferably less than 30% by mass, and most preferably less than 20% by mass relative to mass of a thermoplastic resin forming the toner receptor layer.

The fillers may be organic or inorganic, and substituted with known materials known as stiffeners for binder resins, filling materials, reinforcing materials, etc. Also, the filler may be selected consulting “Handbook: Rubber Plastics Composing Chemicals” (Rubber Digest Ltd.), “New Edition: Plastic Composing Chemicals—Fundamentals And Applications” (Taiseisha), or “Filler Handbook” Taiseisha).

Examples of the inorganic fillers include inorganic fillers and inorganic pigments such as silica, alumina, a titanium dioxide, a zinc oxide, a zirconium oxide, an iron oxide like mica, zinc white, a lead oxide, a cobalt oxide, strontium chromate, molybdenum pigments, smectite, a magnesium oxide, a calcium oxide, a calcium carbonate, mullite, etc. Among them, Silica or alumina is particularly preferred among them. These fillers may be used individually or in combination of two or more. The filler is preferred to take small sizes of particles. If the size of filler particles is larger, the toner receptor layer is apt to have a coarse surface.

The silica may be spherical or amorphous and may be synthesized by a dry method, a wet method or an aerogel method. Surfaces of hydrophobic silica particles may be treated with a trimethylsilyl group or silicon. In this case, the silica particles are preferably colloidal and, further, porous. Examples of the alumina include anhydrous alumina of a crystal form of α, β, γ, δ, ζ, η, θ, κ, ρ or χ; alumina monohydrate such as pseudoboemite, boemite and diaspore; and trihydrate alumina such as gibbsite and bayerite. The alumina hydrate is more preferable than the anhydrous alumina The alumina is preferred to be porous. The alumina hydrate can be synthesized by a sol-gel method in which alumina is precipitated in a solution of an alminium salt or a method in which an alkali aluminate is hydrolyzed. The anhydrous alumina can be derived by heating alumina hydrate for dehydration.

The filler content of is preferably in a range of from 5 to 2000 parts by mass with respect to 100 parts by dry mass of a binder of the toner receptor layer.

The crosslinking agent is blended for the purpose of adjustment of storage stability and thermoplasticity of the toner receptor layer. Compounds used for the crosslinling agent are those having more than two reactive groups, such as an epoxy group, an isocyanate group, an aldehydo group, an active halogen group, an active methylene group, an acetylene group, and other reactive groups conventionally well known, in one molecule. In addition, the crosslinking agent is substituted with compounds having more than two groups capable of forming an ionic bond, a hydrogen bonding, a coordinate bonding, etc. or conventionally available compounds such as coupling agents for resins, hardening agents, polymerization initiators, polymerization promoters, coagulating agents, film forming agents, film forming auxiliary agents, ect. for resins. Examples of the coupling agents include those of a chlorosilane type, a vinylsilane type, an epoxysilane type, an aninosilanetype, an alkoxy aluminum chelate type or a titanate type and, in addition, those disclosed in “Handbook: Rubber·Plastics Composing Chemicals” (Rubber Digest Ltd.).

It is preferred for the toner receptor layer to contain an antistatic or electrostatic charge control agent for the purpose of controlling toner transfer and toner adhesion and preventing the toner receptor layer from adhesion due to electrostatic charges.

Examples of the antistatic agents are not bounded by type and may selected according to purposes. Examples of the antistatic agents include, but not limited to, cationic surface-active agents such as a quatemary ammonium salt, polyamine derivatives, cation-modified polymethyl methacrylate, cation-modified polystyrene, etc.; ampholytic surface-active agents; anionic surface-active agents such as alkyl phosphate, anion polymers, etc.; nonionic surface-active agents such as fatty acid ester, polyethylene oxides, etc.; and polyelectrolyte; and electrconductive metal oxides. In the case where a toner has negative electricity, the electrostatic charge control agent is preferred to be cationic or nonionic. Examples of the electroconductive metal oxides include, but not limited to, ZnO, TiO₂, SnO₂, Al₂O₃, In₂O₃, SiO₂, MgO, BaO, MoO₃, etc. These electroconductive metal oxides may be used individually or in any combination of two or more. Further, the electroconductive metal oxide may contain a hetero elements a dopant, for example Al or In for ZnO, Nb or Ta for TiO₂, Sb, Nb or halogens for SnO₂.

It is allowed to add various additives into materials for the toner receptor layer for the purpose of improvement of stability of recorded images and stability of the toner receptor layer itself Examples of the additives include an antioxidant, an anti-aging agent, an anti-degradation agent, anti-ozonant, an ultraviolet absorption agent, a metal complex, a light stabilizer, an antiseptic agent, a fungicide which are known in the art.

Examples of the antioxidant include, but not limited to, chroman compounds, cumarin compounds, phenolic compounds (e.g. hindered phenol), hydroquinone derivatives, hindered amine derivatives, spiroindan compounds, and those described in, for example, Japanese Unexamined Patent Publication No. 61-159644. Examples of the anti-aging agents include, but not limited to, those described in “Handbook: Rubber·Plastics Composing Chemicals 2^{nd} Revised Edition,” pages from 76 to 121 (1993, Rubber Digest Ltd.). Examples of the ultraviolet absorption agents include, but not limited to, benzotriazole compounds such as described in U.S. Pat. No. 3,533,794, 4-thiazolidine compounds such as described in U.S. Pat. No. 3,352,681, benzophenone compounds such as described in Japanese Unexamined Patent Publication No. 46-2784, and ultraviolet absorptive polymers such as described in Japanese Unexamined Patent Publication No. 62-260152. Examples of the metal complexes include, but not limited to, those described in, for example, U.S. Pat. Nos. 4,241,155, 4,245,018 and 4,254,195, and Unexamined Japanese Patent Publication Nos. 61-88256, 62-174741, 63-199248, 1-75568 and 1-74272. In addition, ultraviolet absorptive agents and light stabilizers described in “Handbook: Rubber Plastics Composing Chemicals 2^{nd} Revised Edition,” pages from 122 to 137 (1993, Rubber Digest Ltd.) can be used.

As was previously mentioned, additives known in the conventional photographic art can be used for the toner receptor layer. Examples of the additives include those described in Research Disclosure Magazine (which is abbreviated to RD) Nos. 17643 (December 1987), 18716 (November 1979) and 307105 (November 1989). These additives appear on the following pages shown in the following Table I.

TABLE I

| | RD No. | RD No. | RD No. |
|---|---|---|---|
| Additive | 17643 | 18716 | 307105 |
| Brightener | 24 | 648R | 868 |
| Stabilizer | 24-25 | 649R | 868-870 |
| Light absorbent | 25-26 | 649R | 873 |
| (UV Absorbent) | | | |
| Color image stabilizer | 25 | 650R | 872 |
| Film hardener | 26 | 651L | 874-875 |
| Binder | 26 | 651L | 873-874 |
| Plasticizer/Lubricant | 27 | 650R | 876 |
| Coating auxiliary additive | 26-27 | 650R | 875-876 |
| (Surface-active agent) | | | |
| Antistatic agent | 27 | 650R | 976-977 |
| Matting agent | — | — | 878-879 |

The toner receptor layer is formed by applying a coating liquid containing a polymer over the support by a wire coater and drying it. It is preferred form the polymer coating layer at a melt flow temperature (MFT) higher than a room temperature for storage before printing and lower than 100° C. for toner particle fixation. Further, the spread of the toner receptor layer is preferably in a range of from 1 to 20 g/m² and more preferably in a range of from 4 to 15 g/m² by dried weight. The toner receptor layer is not bounded by thickness and, however, preferably greater than half of a grain size of a toner used for the toner receptor layer, and more preferably one to three times as large as the grain size of toner particle, and, more specifically, preferred to have a thickness in a range of from 1 to 50 μm, more preferably in a range of from 1 to 30 μm, most preferably in a range of from 2 to 20 μm, and ultimately an a range of from 5 to 15 μm.

The following description will be directed to solid state properties of the toner receptor layer.

It is preferred for the toner receptor layer to have a 180° exfoliation strength at a fixing temperature of a fixing member or device less than 0.1 N/25 mm, more preferably 0.041 N/25 mm. The 180° exfoliation strength can be measured using a surface material by the method meeting JIS K6887.

It is preferred for the toner receptor layer to have a high degree of whiteness, specifically, higher than 85% when estimated by the method meeting JIS P8123 and a spectral reflectivity higher than 85% in a wavelength band of from 440 to 640 nm, and more preferably in a wavelength band of from 400 to 700 nm. A difference between the highest and the lowest spectral reflectivity is preferred to be less than 5% in these wavelength ranges.

More specifically, when specifying the degree of whiteness expressed in the CIE 1976 (L*a*b*) color space, it is preferred that the toner receptor layer has an L* value greater than 80, more preferably greater than 85, and most preferably greater than 90. The white tint is preferably as neutral as possible and, in other words, is of a ((a*)²+(b*)²) value expressed in CIE 1976 (L*a*b*) color space less than 50, more preferably less than 18, and most preferably less than 5.

It is preferred for the toner receptor layer to have a high degree of glossiness after image formation, and, specifically, a degree of 45° glossiness greater than 60, more preferably greater than 75, and most preferably greater than 90, in a range of from a white state (which refers to a state where no toner is applied to the toner receptor layer) to a black state (which refers a state where toner is applied to the toner receptor layer at the highest density). However, the degree of 45° glossiness is preferably less than 110 in the same range. If the degree of 45° glossiness is beyond 110, images formed on the toner receptor layer are apt to have metallic gloss which is undesirable in image quality. The degree of glossiness can be estimated by the method meeting JIS Z8741.

It is preferred for the toner receptor layer to have a high degree of surface smoothness, specifically, an arithmetic mean roughness (Ra) less than 3 μm, more preferably less than 1 μm, and most preferably less than 0.5 μm, ranging over the whole density extent (from the white state to the black state). The arithmetic mean roughness (Ra) can be estimated by the method meeting JIS B0601, B0651 and B0652.

It is further preferred for the toner receptor layer to satisfy at least one, more preferably two or more, and most preferably all, of the following solid state properties (1) to (6):
(1) Melt temperature (Tm): preferably higher than 30° C., but within +20° C. from a melt temperature of the toner
(2) Temperature at which the toner layer attains viscosity of 1×1o⁵CP: preferably higher than 40° C. but lower than that of the toner
(3) Storage elastic modulus (G′) and loss elastic modulus (G″) at a fixing temperature: preferably in a range of from 1×10² to 1×10⁵ Pa and in a range of from 1×10² to 1×10⁵ Pa, respectively
(4) Loss tangent (G″/G′) (a ration of loss elastic modulus (G″) to storage elastic modulus (G′)) at the fixing temperature: preferably in a range of from 0.01 to 10
(5) Storage elastic modulus (G′) at a fixing temperature: preferably in a range of from −50 Pa to +2500 Pa of a storage elastic modulus (G′t) of the toner at fixing temperature
(6) Inclination angle of a molten toner on the toner receptor layer: preferably less than 50°, and more preferably less than 40°.

It is preferred for the toner receptor layer to satisfy the solid state properties descnbed in U.S. Pat. No. 2,788,358, Japanese Unexamined Patent publication Nos. 7-248637, 8-305067 or 10-239889 as well.

It is preferred for the toner receptor layer to have a surface electrical resistivity in a range of from 1×10⁶ to 1×10⁵ Ω/cm² under conditions of a temperature of 25° C. and a relative humidity of 65%. If the lower limit surface electrical resistivity of 1×10⁶ Ω/cm² is exceeded, the toner is transferred to the toner receptor layer too small in amount to form an image having a satisfactory density. On the other hand, if the upper limit electrical resistivity of 1×10¹⁵ Ω/cm² is exceeded, there is generated too much electrical charges which cause toner particles to be transfer in sufficiently. This results in that a toner image is poor in density and electrophotographic paper is apt to gather dust by static electricity during handling it. In addition, the elctrophotographic paper possibly encounter miss-feed, double feed of two or more, an occurrence of charge prints and an occurrence of dropouts. The surface electrical resistivity is measured on a sample under one minute application of 100V in an environment at a temperature of 20° C. and a humidity of 65% after 8-hours humidity regulation of the sample in the same environment by the method meeting JIS K6911 using a measuring instrument, such as Model R8340 (Advantest Co., Ltd.).

As was previously mentioned, the electrophotographic paper may be provided with certain layers such as a surface protective layer, a backing layer, an interlayer adhesion improvement layer, an under layer, a cushioning layer, an electrostatic charge control or antistatic layer, a reflection layer, a color adjusting layer, a storage stability improvement layer, an anti-adhesion layer, an anti-curling layer and a smoothing layer. These layers may be provided individually or in any combination of two or more.

The surface protective layer is formed over a surface of the toner receptor later for the purpose of surface protection, improvement of storage stability, improvement of handling adaptability, creation of writability, improvement of transport quality through electrophotographic equipments, creation of anti-offset property.

The surface protective layer may be single-layered or multi-layered. It is preferred that the outermost layer of the electrophotoelectric paper (the surface protective layer when it is formed) is well compatible with a toner in terms of fixing performance. Specifically, the outermost layer is preferably such that the contact angle of a molten toner is in a range of from 0 to 40°. Although various types of thermoplastic resins or thermosetting resins can be used for a binder of the surface protective layer, it is preferred to use the same resin as used for the toner receptor layer. However, the surface protective layer is not required to be the same in thermo dynamic and electrostatic characteristics as the toner receptor layer and can be optimized. The surface protective layer may be blended with additives that are usable for the toner receptor layer such as in particular the matting agent as well as the release agent used for the toner receptor layer. Various matting agents conventionally known can be used.

The backing layer is formed on a reverse side surface of the paper support (a surface opposite to an obverse side surface on which the toner receptor layer is formed) for the purpose of creation of back side printing adaptability, and improvement of back side printing quality, curling balance and transport quality through electrophotographic equipments. Though the backing layer is not always bounded by color, it is preferred for the backing layer to be white in the case where the photoelectric paper is two-sided It is preferred that the backing layer has a degree of whiteness and a spectral reflectivity both higher than 85% similarly to the toner receptor layer. In order to improve double-side printing adaptability of the electrophotoelectric paper, the backing layers for the both surfaces may be identical in structure with each other. Further, the backing layer may be blended with additives, specifically, the matting agent and the electrostatic charge control or antistatic agent previously described. In the case of using release oil for the fixing rollers, it is preferred for the backing layer to be of an oil absorbing type. The backing layer is preferably between 0.5 and 10 μm in thickness and may be single-layered or multi-layered.

It is preferred to form the interlayer adhesion improvement layer for the purpose of improvement adhesion between the toner receptor layer and the paper support. The interlayer adhesion improvement layer may be blended with various additives, in particular a crosslinking agent, previously described. Further, it is preferred that the electrophotogreaphic paper has a cushioning layer between the interlayer adhesion improvement layer and the toner receptor layer.

The intermediate layer may be formed between the paper support and the interlayer adhesion improvement layer, between the interlayer adhesion improvement layer and the cushioning layer, between the cushioning layer and the toner receptor layer, or between the toner receptor layer and the storage stability improvement layer. In the case where the electrophotogreaphic paper consists of the paper support, the toner receptor layer and the intermediate layer, it is of course to put the intermediate layer between the paper support and the toner receptor layer.

The electrophotogreaphic paper is not bound by thickness and, however, preferably in a rage of from 50 to 550 μm, and more preferably in a range of from 100 to 350 μm, according to its applications.

In electrophotographic printing or copying, images are formed by causing the toner receptor layer to receive a toner or toners. The toner comprises at least a binding resin and a coloring agent and, if necessary, a release agent and other components.

Examples of the binding resin include, but not limited to, a styrene type such as styrene, parachlorosthylene, etc.; a vinyl ester type such as vinyl naphthalene, vinyl chloride, vinyl bromide, vinyl fluoride, vinyl acetate, vinyl propionate, vinyl benzoate, vinyl butyrate, etc.; a methylene aliphatic carboxylate ester type such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate, butyl methacrylate, etc,; a vinyl nitrile type such as acrylonitrile, methacrylonitrile, acrylamide, etc.; s vinyl ether type such as vinyl methyl ether, vinyl ethyl ether, vinyl isobutyl ether, etc.; N-vinyl compounds such as N-vinyl pyrrole, N-vinyl carbazole, N-vinyl indole, N-vinyl pyrrolidone, etc.; homopolymers or copolymers of vinyl monomers of vinyl carboxylate such as methacrylic acids, acrylic acids, cinnamic acids, etc.; and various types of polyester. These binding resin may be used in combination with various types of wax. Among them, it is preferred to use the same type of resin as used for the toner receptor layer.

The coloring agent is not bounded by type and may be of the same type as ordinarily used for toners. Examples of the coloring agent include, but not limited to, pigments such as carbon black, chrome yellow, Hansa yellow, benzidine yellow, slen yellow, quinoline yellow, permanent orange GTR, pyrazolone orange, Vulcan orange, Watchung red, permanent red, brilliant carmine 3B, brilliant carmine 6B, Deipon oil red, pyrazalone red, redole red, rhodamine B lake, lake red C, rose Bengal, aniline blue, ultramarine blue, Carco oil blue, methylene blue chloride, phthalocyanine blue, phthalocyanine green, malachite green oxalate, etc.; and dyes such as acridine dyes, xanthene dyes, azoic dyes, benzoquinone dyes, axine dyes, anthraquinone dyes, thioindigo dyes, dioxazine dyes, thiazine dyes, azomethine dyes, indigo dyes, thioindigo dyes, phthalocyanine dyes, aniline black dyes, polymethine dyes, triphenylmethane dyes, diphenylmethane dyes, thiazine dyes, thiazole dyes, xanthene dyes, etc. These pigments or dyes may be used individually or in any combination of two or more. The coloring agent content is preferably in, but not limited to, a range of from 2 to 8% by mass. The electrophotographic paper possibly encounters aggravation of tintorial power if the coloring agent content is less than 2% by mass, or aggravation of transparency if it exceeds 8% by mass.

The release agent is not bounded by type and may be of the same type as ordinarily used for toners. Examples of the release agent include, but not limited to, comparatively low molecular weight and highly crystalline polyethylene wax, Fischer-Tropsch wax, amide wax, polar wax containing nitrogen such as a compound having a urethane bond. The polyethylene wax is preferably of a molecular weight less than 1000, and more preferably in a range of from 300 to 1000.

The compound having a urethane bond is favorable from the viewpoint that it keeps itself in a solid state due to coagulation power of a polar group even though it has only a small molecular weight and can be set to a higher melt temperature with respect to its molecular weight. The molecular weight of the compound is preferably in a range of from 300 to 1000. Examples of raw materials for the compound include various combinations of substances such as a combination of a diisocyanate compound and monoalcohol, a combination of a monoisocyanic acid and monoalcohol, a combination of dialcohol and a monoisocyanic aciod, a combination of trialcohol and a monoisocyanic acid, a combination of triisocyanate and a monoisocyanic acid, a combination of triisocyanic compound and monoalcohol, etc. In order to keep the compound from having a higher molecular weight, it is preferred to combine compounds having a multifunctional group and a monofunctional group, respectively, and is important to combine them so as to have quantitatively equivalent functional groups.

Example of the monoisocyanicate compound include, but not limited to, dodecyl isocyanate, phenyl isocyanate, derivatives of phenyl isocyanate, naphthyl isocyanate, hexyl isocyanate, benzyl isocyanate, butyl isocyanate, aryl isocyanate, etc. Example of the diisocyanate compound include, but not limited to, tolylene diisocyanate, 4, 4′ diphenyl methane diisocyanate, toluene diisocyanate, 1, 3-phenylene diisocyanate, hexamethylene diisocyanate, 4-methyl-m-phenylene diisocyanate, isophorone diisocyanate, etc. Example of the monoalcohol include, but not limited to, methanol, ethanol, propanol, butanol, pentanol, hexanol, heptanol, etc. Example of the dialcohol include, but not limited to, various glycol such as ethylene glycol, diethylene glycol, triethylene glycol, trimethylene glycol, etc. Example of trialcohol include, but not limited to, trimethylol propane, triethylol propane, trimethanol ethane, etc.

The urethane compounds may be used in the form of mixed pulverized type toner by being blended together with a resin and a coloring agent like ordinary release agents.

When using the urethane compounds for an emulsion polymerization-coagulation melt type of toner, a dispersion liquid of particles of the release agent is prepared by dispersing the compound in water together with a polyelectrolyte such as an ionic surface-active agent, a polymer acid or a polymer base; heating to a temperature higher than its melt temperature, and shearing the compound to particulates of a grain size less than 1 μm. The dispersion liquid of the release agent can be used together with a dispersion liquid of resin particles and/or a dispersion liquid of coloring agent.

The toner may be blended with other components such as an internal additive, an electrostatic charge control or antistatic agent, inorganic fine particles, etc.

Examples of the internal additive include, but not limited to, magnetic materials such as metals like ferrite, magnetite, reduced iron, cobalt, nickel, manganese, etc.; alloys of these metals; and compounds containing these metals.

Examples of the electrostatic charge control agent include, but not limited to, dye such as quaternary ammonium salt compounds, nigrosin compounds, aluminum, a complex of iron or chrome; and a triphenylmethane type of pigment, etc. which are ordinarily used as an electrostatic charge control agent. In terms of controlling ionic strength which affects stability of the toner during coagulation and melt and reducing wastewater pollution, it is preferred to use an electrostatic charge control agent hardly soluble in water.

Examples of the inorganic fine particles include, but not limited to, external additives ordinarily used for surfaces of toner particles such as silica, alumina, titania, calcium carbonate, magnesium carbonate, tricalcium phosphate, etc. It is preferred to use the inorganic particles in the form of a dispersion with an ionic surface-active agent, polymer acid and/or a polymer base.

Surface-active agents can be used for the purpose of emulsion polymerization, seed polymerization, dispersal of pigment dispersal of resin particles, dispersal of release agent coagulation, and stabilization of them. It is effective to use an anionic surface-active agent of a sulfurric ester salt type, a sulfonic ester salt type, a phosphate salt type, or a soap type; a cationic surface-active agents of an amine salt type or a quaternary ammonium salt type; and nonionic surface-active agents of a polyethylene glycol type, a type of alkyl phenol ethylene oxide adduct or a polyhydric alcohol type; etc. Generally available mills such as a rotary shear type of homogenizer, a ball mill, a sand mill or the like may be used For dispersion of these additives.

The toner may be further blended with an external additive as appropriate. Examples of the external additive include, but not limited to, inorganic particles such as SiO₂ particles, TiO₂ particles, Al₂O₃ particles, CuO particles, ZnO particles, SnO₂ particles, Fe₂O₃ particles, MgO particles, BaO particles, CaO particles, K₂O particles, NaO₂ particles, ZrO₂ particles, CaO.SiO₂ particles, K₂O.(TiO₂)ₙ particles, Al₂O₃.2SiO₂ particles, CaCO₃ particles, MgCO₃ particles, BaSO₄ particles and MgSO₄ particles; and organic particles such as powder of fatty acids, derivatives of the fatty acids or metal salts of them, and powder of fluorocarbon resins, polyethylene resins or acryl resins. It is preferred that these particles have average grain sizes in a range of from 0.01 to 5 μm, and more preferably in a range of from 0.1 to 2 μm.

The toner is not bounded by production method. However, it is preferred to employ a method comprising the following processes (i) to (iii):

(i) a process of preparing a dispersion liquid of coagulated resin particles in a dispersing liquid
(ii) a process of mixing a dispersion liquid of particulates into the dispersion of coagulated resin particles to form particulate-adhered coagulated resin particles
(iii) a process of thermally fusing the particulate-adhered coagulated resin particles to form toner particles

It is preferred for the toner particles to have a volume-average grain size in a range of from 0.5 to 10 μm. The toner possibly causes adverse repercussions in handling adaptability (supply adaptability, cleaning adaptability, flowability) and possibly decreases its productivity if the volume-average grain size is too small or possibly causes adverse repercussions in graininess and image transferability which affect image quality and image resolution if it is too large. It is further preferred for the toner particles to have a volume-average grain size distribution index (GSDv) less than 1.3 besides satisfaction of the above requirement for volume-average grain size and, further, a ratio (GSDv)/GSDn) between a volume-average grain size distribution index (GSDv) and a number-average grain size distribution index (GSDn) equal to or greater than 0.9. In addition, it is preferred for the toner to have an average of profile factors expressed by the following equation in a range of from 1.00 to 1.50 besides satisfaction of the above requirement for volume-average grain size.
Profile factor=(π×L²)/(4×S)
where L is the greatest grain size of toner particle and S is the projected area of toner particle.

When satisfying the requirements as set forth above, the toner has notable effects on image quality, more particularly graininess and resolution of an image, prevents an occurrence of drop-outs accompanying toner image transfer and/or an occurrence of blurred toner image, and is apt to have no adverse effect on its handling adaptability even though the average grain size is too small.

It is favorable that that the toner itself has a storage elastic modulus (G′) in a range of from 1×10² to 1×10⁵ Pa when measured in an angular frequency of 10 rad/sec at a temperature of 150° C. in terms of improvement of image quality and prevention of an occurrence of offsets in the fixing process.

The thermal recording paper comprises, for example, at least a thermal recording layer formed as an image recording layer on the paper support of the present invention and is used in a thermo-autochrome method (AT method) which forms an image by repeating application of heat through a heat-sensitive head and fixation by ultraviolet radiation.

The sublimation transfer paper comprises, for example, at least an ink layer containing thermal diffusion dye (sublimatic dye) formed as an image recording layer on the paper support of the present invention and is used in a sublimation transfer method which transfers the thermal diffusion dye from the ink layer to a sublimation transfer paper by application of heat by a heat-sensitive head.

The thermal transfer paper comprises, for example, at least a hot-melt ink layer formed as an image recording layer on the paper support of the present invention and is used in a melt transfer method which forms an image is formed by heating and transferring the hot-melt ink from the hot-melt ink layer to a thermal transfer paper by a heat-sensitive head.

The silver halide photographic paper comprises, for example, image recording layers for yellow (Y), magenta (M) and cyan (C) formed on the paper support of the present invention and is suitably used in a silver halide photographic method which performs color development, bleaching and fixing, washing, and drying by passing an exposed silver halide photographic paper through processing baths.

The ink-jet paper comprises, for example, a color material receptor layer capable of receiving color materials such as liquid inks, namely an aqueous ink (comprising dye or pigment as a color material) and an oil-based ink, or solid inks that are solid at a normal temperature and is melted and liquidized upon recording, formed as an image recording layer on the paper support of the present invention.

The image recording medium is suitably used as printing paper for offset printing, gravure printing or electrophotographic printing. In this case, it is preferred for the printing paper to have high mechanical strength in terms of application of ink by a printing machine.

In the case where the base paper is used for the support for the image recording medium, it is preferred to add a filler, a softening agent and/or paper making internal auxiliary additives to the base paper.

Examples of the filler include, but not limited to, inorganic fillers such as clay, burned clay, diatom earth, talc, calyon, kaolin, burned kaolin, delamikaoline, calcium carbonate heavy, precipitated calcium carbonate light, magnesium carbonate, barium carbonate, a titanium dioxide, a zinc oxide, a silicone dioxide, amorphous silica, an aluminum hydroxide, a calcium hydroxide, a magnesium hydroxide, a zinc hydroxide, etc; and organic fillers such as a urea-formalin resin, a polystyrene resin, a phenol resin, fine hollow particles, etc. These fillers may be selectively used individually or in any combination of tow or more of them.

Examples of the paper making internal auxiliary additives include a nonionic retention aid, a cationic retention aid, a freeness improver, a paper strength improver, an internal sizing agent, etc. More specific examples include, but not limited to, basic aluminum compounds such as aluminum sulfate, aluminum chloride, soda aluminate, basic aluminum sodium, basic aluminum polyhydroxide, etc.; water-soluble polymers such as starch, processed starch, polyacrylarnide, urea resins, melamine resins, epoxy resins, polyamide resins, polyamine resins, polyethylene imine, vegetable gum, polyvinyl alcohol, latex, polyethylene oxides; and compounds such as derivatives or modified products of them. These materials individually have one or more functions of a paper making internal auxiliary additive. Examples of the internal sizing additives include alkyl ketene dimmer compounds, alkenyl succinic anhydride compounds, styrene-acrylic compounds, higher fatty acid compounds, petroleum resin sizing additives, rosin sizing additives, etc.

Further, it is sensible to add paper making internal additives such as dye, a fluorescent whitening agent, defoamer, a pitch control agent, a slime control agent, etc.

The printing paper described above is suitably used for relief printing, gravure printing or electrophotography and, especially, for offset printing.

The image recording medium described above has high surface flatness and smoothness, and distinguished surface glossiness, and thereby being capable of forming high quality images when used for electrophotographic recording paper, heat sensitive color recording paper, sublimation transfer recording paper, thermal transfer recording paper, silver halide photographic paper or ink-jet recording paper.

In order to make assessment of properties of supports and image recording paper using the support of specific embodiments offered by way of example.

### EXAMPLE 1

A paper support for image recording paper of example 1 (Ex1) was prepared in the following manner. A pulp stock having an average fiber length of 0.65 mm was prepared by beating bleached broadleaf tree kraft pulp (LBKP) to a freeness of 280 ml (Canadian Standard Freeness: C.S.F.) using a disk refiner. Thereafter, 6% by mass of cationic starch, 0.4% by mass of alkyl ketene dimmer (AKD), 0.3% by mass of anionic polyacryamide, 0.2% by mass of epoxydized fatty acid amide (WFA) and 0.2% by mass of polyamide polyamine epichlorohydrin were added into the pulp stock. In this instance, an alkyl part of the alkyl ketene dimmer (AKD) is derived from a fatty acid primarily composed of a behenic acid as a primary component, and the a fatty acid part of the epoxydized fatty acid amine is derived from a fatty acid primarily composed of a behenic acid as a primary component. The pulp stock thus prepared was processed to make 140 g/m² absolute dry basic weight of base paper using a fourdrinier machine.

Subsequently, the base paper was calendered using a long nip sift calender machine equipped with a metal roller, a press shoe and a synthetic resin belt such as sown in FIG. 1 that has a nip length of 50 mm. The metal roller was of a type having a surface treated by tungsten carbide-cobalt thermal spraying so as to be improved in heat resistance and rustproof The carendering was performed under the following conditions:
Surface temperature of the metal roller (for obverse side surface): 260° C.
Surface temperature of the press shoe (for reverse side surface): 50° C.
Nip pressure: 210 kN/m²
Paper feed speed: 390 m/min

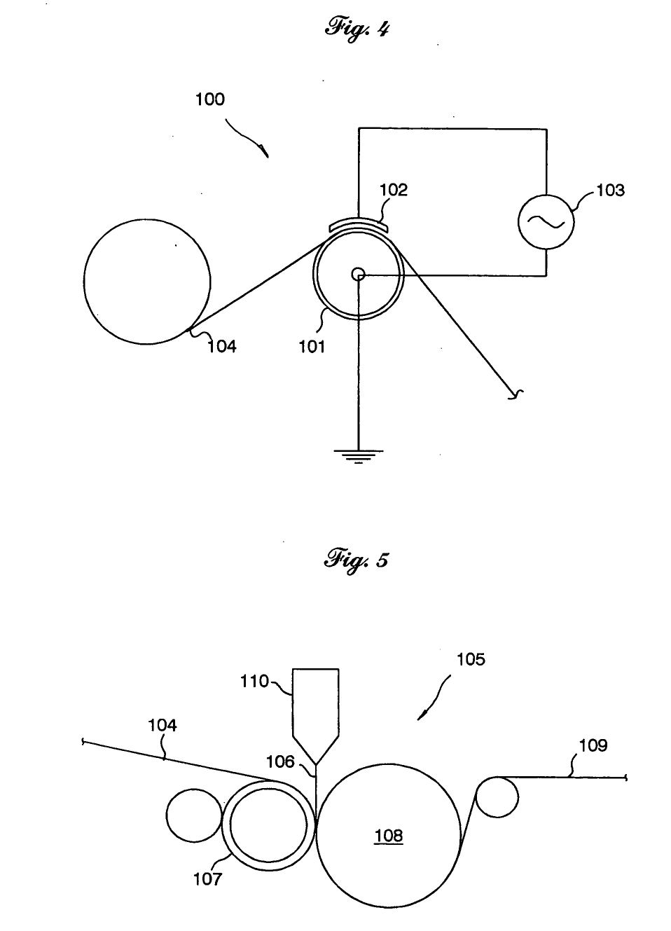

A corona discharge treatment was applied to the reverse side surface of the base paper at a wattage density of 25 W/m²/min using a corona discharge treating machine which will be described later referring to FIG. 4. Consecutively to the corona discharge treatment, a polyethylene composition comprising high density polyethylene (MFR: 14.8; density. 0.959) was coated on the reverse side surface of the base paper at a coating speed of 400 m/min using a melt extrusion coating machine which will be described later referring to FIG. 5 such as to form a polyolefin coating layer 25 μm thick. Subsequently, a corona discharge treatment was applied to the obverse side surface of the base paper at a wattage density of 22 W/m²/min in the same manner using the corona discharge treating machine and, consecutively, a polyethylene composition which comprises low density polyethylene (MFR: 14.9; density 0.919) containing 12% by mass of titanium dioxide was coated on the obverse side surface of the base paper at a coating speed of 400 m/min in the same manner using the melt extrusion machine such as to form a polyolefin coating layer 30 μm thick.

Referring to FIG. 4 schematically showing a corona discharge treating machine 100 by way of example, the corona discharge treating machine 100 comprises a dielectric layer-plated metal roller 101, an insulated electrode 102 and a power source 103. When energizing the electrode gap with high-frequency voltage or high voltage, coronas are discharged between the metal roller 101 and the insulated electrode 102. While the base paper 104 passes through between the metal roller 101 and the insulated electrode 102, it is treated by corona discharge.

FIG. 5 schematically shows a melt extrusion coating machine 105 by way of example. The melt extrusion coating machine 105 comprises a melt extruder 110 for extruding a molten polymer film 106, a clamp roller 107 and a cooling roller 108. While the corona treated base paper 104 passes through a nip between the clamp roller 107 and the cooling roller 108, the molten polymer film 106 is laminated and adhered to the surface of the base paper 104. As the base paper 104 travels ahead, the molten polymer film 106 adhered to the base paper 104 is cooled down by the cooling roller 108 to form a polymer coating layer 109.

### EXAMPLES 2-5 AND COMPARATIVE EXAMPLES 1-5

Base paper of examples 2-5 (Ex2-Ex5) and comparative examples 1-5 (Exc1-Exc5) were prepared in the same manner as the base paper of example 1 except for calendaring temperatures as indicated in Table II.

TABLE II

| | | | Polymer coating layer | | | | |
|---|---|---|---|---|---|---|---|
| | Carendering | | | | | Compounded resin ratio | |
| | Temperature (° C.) | | Coating | Corona discharge treatment | | Obverse | Reverse |
| | Metal | Resin | speed | Obverse | Reverse | layer | layer |
| | roller | roller | (m/min) | (W/m²/min) | (W/m²/min) | (30 μm) | (30 μm) |
| Ex 1 | 260 | 50 | 400 | 22 | 25 | C | D |
| Ex 2 | 210 | 45 | 700 | 150 | 25 | C:B = 6:4 | D |
| Ex 3 | 280 | 45 | 400 | 30 | 25 | C:B = 6:4 | E |
| Ex 4 | 300 | 57 | 350 | 65 | 25 | C | E |
| Ex 5 | 290 | 50 | 450 | 21 | 25 | A:B = 3:7 | D |
| Exc 1 | 190 | 50 | 400 | 30 | 25 | C | D |
| Exc 2 | 380 | 100 | 400 | 30 | 25 | C:B = 6:4 | D |
| Exc 3 | 350 | 100 | 450 | 9 | 25 | B | E |
| Exc 4 | 210 | 45 | 200 | 200 | 25 | C:B = 6:4 | E |
| Exc 5 | 210 | 50 | 450 | 13 | 25 | A | D |

In Table II, compounded resins, “A” to “E” are as below:
A: Polyethylene resin: MFR = 3.5; Density = 0.924
B: Polyethylene resin: MFR = 7.6; Density = 0.927
C: Polyethylene resin: MFR = 14.9; Density = 0.919
D: Polyethylene resin: MFR = 14.8; Density = 0.959
E: Polyethylene resin: MFR = 16.7; Density = 0.967

The base paper and the supports of the respective examples Ex 1-5 and comparative examples Exc 1-5 were assessed on their qualities, and more specifically on surface texture quality and property of the base paper and the support. The result is shown in Table III.

The base paper was visually examined on surface texture quality in terms of the presence of cockles and dents and glossiness of the base paper, and assessed in the following grades.

Assessment Grade for Cockles and Dents

A: Very excellent (no cockles and dents)
B: Excellent
C: Poor
D Very poor (a large number of cockles and dents)

The base paper was visually examined on surface texture quality in terms of glossiness of the base paper, and assessed in the following grades.

Assessment Grade for Glossiness

A: Very excellent
B: Excellent
C: Poor
D: Very poor

The support was measured on surface texture quality of the support in terms of surface roughness (SRa) with a cutoff level between 1 and 10 mm by a surface figuration measuring device such as Surfcom Model 570A-3DF (Tokyo Seimitsu Co., Ltd.), and assessed in the following grades.

Assessment Grade for Surface Rouglness (SRa)

A: Very excellent (SRa: not greater than 0.15 μm)
B: Excellent (SRa: greater than 0.15 μm and not greater than 0.20 μm)
C: Moderate (SRa: greater than 0.20 μm and not greater than 0.30 μm)
D: Poor (SRa: greater than 0.30 μm and not greater than 0.40 μm)
E: Very Poor (SRa: greater than 0.40 μm)

The support was assessed visually examined on surface texture quality in terms of the number of pits per square centimeter, and assessed in the following grades.

Assessment Grade for Pits

A: Very excellent (less than 20)
B: Excellent (more than 21 and less than 50)
C: Moderate (more than 51 and less than 100)
D: Poor (more than 101 and less than 200)
E: Very Poor (more than 201)

The support was examined on adhesion between base paper and polymer coating layer in terms of peel strength of a sample support of 1.5 cm width on a tensile test, and assessed in the following grades.
A: Very excellent (peel strength: greater than 80 g)
B: Excellent (peel strength: greater than 60 g and not greater than 80 g)
C: Moderate (peel strength: greater than 50 g and not greater than 60 g)
D: Poor (peel strength: greater than 40 g and not greater than 50 g)

E: Very Poor (peel strength: not greater than 60 g)

TABLE III

| | Base paper property | | Polymer coated support property | | |
|---|---|---|---|---|---|
| | Cockle/Dent | Glossiness | Roughness | Pits | Adhesion |
| Ex 1 | A | A | A | A | A |
| Ex 2 | A | | | | A |
| Ex 3 | A | A | A | A | A |
| Ex 4 | A | A | A | A | A |
| Ex 5 | A | A | A | A | B |
| Exc 1 | A | C | C | C | A |
| Exc 2 | D | B | D | A | B |
| Exc 3 | C | A | | A | D |
| Exc 4 | A | C | D | D | A |
| Exc 5 | A | C | A | C | D |

### EXAMPLES 6-10 AND COMPARATIVE EXAMPLES 6-10

Electrophotographic paper of examples 6-10 (Ex 6-Ex 10) and comparative examples 6-10 (Exc 6-Exc 10) using the supports of Examples 1-5 and comparative examples 1-5, respectively, were prepared in the following manner.

A coating liquid for the toner receptor layer was prepared in such a way as follows. A dispersion liquid of titanium dioxide was made by dispersing a dispersion liquid comprising 40.0 g of titanium dioxide (Taipek A-220: Ishihara Sangyo Co., Ltd.) and 2.0 g of polyvinyl alcohol (PVA102: Kurare Co., Ltd.) in 58.0 g of ion-exchange water using a dispersion machine (Model NBK-2: Nihon Seild Co., Ltd.). Thereafer, a toner receptor coating liquid was made by mixing 15.5 g of the titanium dioxide dispersion liquid prepared as above, 15.0 g of dispersion liquid of carnauba wax (Serozole 524: Chukyo Oil & Fats Co., Ltd.), 100.0 g of dispersion water of a polyester resin (KAZ-7049: Unitika Ltd) having a solid content of 30% by mass, 0.2 g of viscosity improver (Alcox E30: Meisei Chemical Co., Ltd.), 0.5 g of anionic surface active agent (AOT), and 80 ml of ion-exchange water. Viscosity and surface tension of the coating liquid were adjusted to 40 mPa·s and 34 mN/m, respectively.

Separately, a coating liquid for the backing layer was prepared by mixing 100 g of dispersion water of an acrylic resin (Hyros XBH-997L: Seiko Chemical Industry Co., Ltd.) having a solid content of 30% by mass, 5.0 g of matting agent (Tecpomer MBX-12: Sekisui Chemical Co., Ltd.), 10.0 g of release agent (Hydrin D337: Chukyo Oil & Fats Co., Ltd.), 2.0 g of viscosity improver (CMC), 0.5 g of anionic surface active agent (AOT) and 80 ml of ion-exchange water. Viscosity and surface tension of the cast coating liquid was adjusted to 35 mPa·s and 33 mN/m, respectively.

A backing layer was formed on the reverse side surface of each of the paper supports of examples Ex 1-4 and comparative examples 1-4 by applying the coating liquid for the backing layer prepared as above using a bar coater such as to have a dry spread of 9 g/m². Subsequently, a toner receptor layer was formed on the obverse side surface of the paper support by applying the coating liquid for the toner reception layer prepared as above using a bar coater such as to have a dry spread of 12 g/m². In this instance, the toner receptor layer was adjusted in pigment content to 5% by mass with respect to the thermoplastic resin. Then, the toner receptor layer and the backing layer were dried by an online hot-air blower. The hot-air flow rate and hot-air temperature were adjusted so as to dry out the layers within two minutes after application of the layers. The dry point was set to a surface temperature of the coating layer becoming equal to a wet-bulb temperature of the hot-air. After drying, the paper support was further calendered using a gloss calendering machine with a metal roller kept at a surface temperature of 40° C. under a nip pressure of 14.7 kN/m² (15 kgf/cm²) to complete the electrophotographic paper.

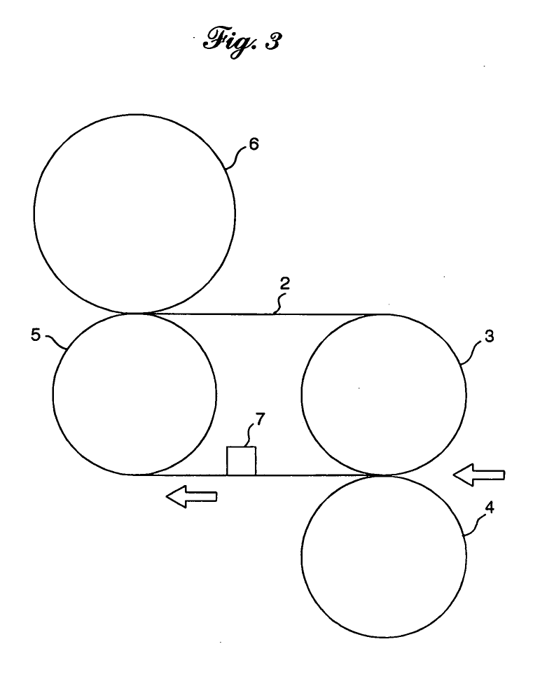

A sample pattern of images was formed on the electrophotographic paper of the examples 6-10 and comparative examples 6-10 using a full color laser printer, DocuColor Moel 1250-PF (Fuji Xerox Co., Ltd), with the fixing device replaced by a belt-fixing device shown in FIG. 3.

Referring to FIG. 3 showing a belt-fixing device 1, an endless fixing belt 2 is mounted between a heating roller 3 and a tensioning roller 5. There are provided a cleaning roller 6 above the tensioning roller 5, a pressure roller 4 below the heating roller 3, and a cooling device 7 disposed between the heating roller 3 and the tensioning roller 5. The electrophotographic paper with a latent toner image formed thereon is fed into a nip between the heating roller 3 and the pressure roller 4 under a nip pressure of 0.2 Mpa (2 kGf/cm²), and transported by the fixing belt 2 at a speed of 30 mm/sec. In this instance, the heating roller 3 was kept at a temperature of 150° C. which is a fixing temperature, and the pressure roller 4 was kept at a temperature of 120° C. During the transport, the electrophotographic paper 1 was cooled by the cooling device 7 and, subsequently, cleaned by the cleaning roller 6 to complete an electrophotographic print.

The electrophotographic prints made from the electrophotographic paper of examples Ex 6-Ex 10 and comparative examples Exc 6-Exc 10 were assessed on image quality and glossiness. The result is shown in Table IV.

The image quality was visually examined and assessed in the following classes.

Assessment Grade for Image Quality

A: Very excellent (acceptable for high quality recording paper)

B: Excellent (acceptable for high quality recording paper)

C: Average (unacceptable for high quality recording paper)

D: Poor (unacceptable for high quality recording paper)

E: Very poor (unacceptable for high quality recording paper)

The glossiness was visually examined and assessed in the following classes.

Assessment Grade for Glossiness

A: Very excellent (acceptable for high quality recording paper)
B: Excellent (acceptable for high quality recording paper)
C: Average (unacceptable for high quality recording paper)
D: Poor (unacceptable for high quality recording paper)

E: Very poor (unacceptable for high quality recording paper)

TABLE IV

| | Support | Image quality | Glossiness |
|---|---|---|---|
| Ex 6 | Ex 1 | A | A |
| Ex 7 | Ex 2 | A | A |
| Ex 8 | Ex 3 | A | A |
| Ex 9 | Ex 45 | A | A |
| Ex 10 | Ex 5 | A | A |
| Exc 6 | Exc 1 | C | C |
| Exc 7 | Exc 2 | E | B |
| Exc 8 | Exc 3 | C | B |
| Exc 9 | Exc 4 | D | D |
| Exc 10 | Exc 5 | C | C |

### EXAMPLES 11-15 AND COMPARATIVE EXAMPLES 11-15

Silver halide photographic print paper of examples 11-15 (Ex 11-Ex 15) and comparative examples 11-15 (Exc 11-Exc 15) using the supports of Examples 1-5 and comparative examples 1-5, respectively, were prepared in the following manner.

The photographic printing paper was made by forming a gelatin under layer (a spread of 0.1 g/m²), a layer of silver halide gelatin emulsion for yellow (a spread of 10 g/m²), a gelatinous intermediate layer, a layer of silver halide gelatinous emulsion for magenta (a spread of 10 g/m²), a gelatin intermediate layer, a layer of silver halide gelatin emulsion for cyan (a spread of 10 g/m²), and a gelatinous protection layer, in this order from the bottom on the obverse side surface of the support.

A sample print was made by forming a test image on the photographic printing paper of the examples 11-15 and comparative examples 11-15 and developing the paper. The printed image was visually examined on surface smoothness in terms of minute concavities and convexities less than 1 mm, and assessed in the following classes.

Assessment Grade for Glossiness

A: Very excellent (acceptable for high quality recording paper)
B: Excellent (acceptable for high quality recording paper)
C: Average (unacceptable for high quality recording paper)
D: Poor (unacceptable for high quality recording paper)
E: Very poor (unacceptable for high quality recording paper)

Further, the printed image was visually examined on surface flatness in terms of undulations between 5 and 6 mm, and assessed in the following classes.
A: Very excellent (acceptable for high quality recording paper)
B: Excellent (acceptable for high quality recording paper)
C: Average (unacceptable for high quality recording paper)
D: Poor (unacceptable for high quality recording paper)

E: Very poor (unacceptable for high quality recording paper)

TABLE V

Surface flatness and smoothness

| | | Smoothness | Flatness |
|---|---|---|---|
| | | (irregularities | (undulations |
| | Support | less than 1 mm) | between 5 and 6 mm) |
| Ex 11 | Ex 1 | A | A |
| Ex 12 | Ex 2 | B | A |
| Ex 13 | Ex 3 | A | A |
| Ex 14 | Ex 4 | A | A |
| Ex 15 | Ex 5 | A | A |
| Exc 11 | Exc 1 | C | C |
| Exc 12 | Exc 2 | B | D |
| Exc 13 | Exc 3 | B | C |
| Exc 14 | Exc 4 | D | D |
| Exc 15 | Exc 5 | D | A |

As apparent from Table III, based on the acknowledgement of the fact that the base paper used for the supports of comparative examples 1-5 are different from those for supports used for the supports of examples 1-5 in terms of an occurrence of cockles and pits, it is proved that the supports of examples 1-5 which were coated with a polymer coating layer on both surfaces after calendered at a surface temperature in a range of from 200 to 350° C. on the obverse side surface and subsequently treated by corona discharge treatment at a wattage density in a range of from 15 to 150 W/m²/min on both surfaces are well prevented from an occurrence of pits and show good surface texture quality and superior adhesion between the base paper and the polymer coating layer. In particular, the supports of examples of 1, 3 and 4 that have the obverse side polymer coating layer containing more than 50% by mass of a polyethylene resin having a MER in a range of from 10 to 20 and a density in a range of from 0.195 to 0.930 are significantly superior in pit proof performance and have distinguished adhesion between the base paper and the polymer coating layer as compared with the others.

On the contrary, the support of comparative example 1 whose base paper celendered at a temperature less than 200° C. is poor in glossiness produces a lot of pits. The support of comparative example 2 whose base paper has a lot of cockles and dents is poor in surface texture quality. The support of comparative example 3 treated by corona discharge treatment at a wattage density less than 150 W/m²/min on the obverse side surface is poor in surface texture quality and adhesion between the base paper and the polymer coating layer. The support of comparative example 4 treated by corona discharge treatment at a wattage density greater than 150 W/m²/min on the obverse side surface and having a polymer coating layer formed at a coating speed less than 250 m/min on the obverse side surface is poor in surface texture quality and has a lot of pits. The support of comparative example 5 having a polymer coating layer that contains more than 50% by mass of polyolefin resin having MFR less than 10 has a lot of pits and is poor in adhesion between the base paper and the polymer coating layer.

As apparent from Table IV, it is proved that the electrophotographic recording paper of examples 6-10 using the supports of examples 1-5, respectively, is capable of forming high quality and glossy images. Further, as apparent from Table V, it is proved that the photographic printing paper of examples 11-15 using the supports of examples 1-5, respectively, is capable of forming smooth images.

While the exemplary embodiments described above are presently preferred, it should be understood that the embodiments are offered by way of example only. Accordingly, the present invention is not limited to a particular embodiment, but extends to various modifications that nevertheless fall within the scope of the appended claims.

What is claimed is:

1. A support for an image recording medium, comprising:
base paper, and
a polymer coating layer formed on both obverse and reverse side surfaces of said base paper treated by soft calendaring treatment and subsequently corona discharge treatment at a wattage density in a range of from 15 to 150 W/m²/min;
wherein said obverse side surface of said base paper is calendered at a surface temperature in a range of from 200 to 350° C.

2. The support for an image recording medium as defined in claim 1, wherein said polymer coating layer contains a polyolefin resin.

3. The support for an image recording medium as defined in claim 1, wherein said polymer coating layer on at least said obverse side surface of said base paper contains more than 50% by mass of a polyethylene resin having an MRF in a range of from 10 to 20 a wattage density in a range of 0.195 to 0.930.

4. The support for an image recording medium as defined in claim 1, wherein said polymer coating layer is formed at a coating speed greater than 250 m/min with a melt extrusion coating machine.

5. A method for manufacturing a support for an image recording medium that comprises base paper and a polymer coating layer formed on both obverse side and reverse side surfaces of said base paper, comprising the steps of:
treating said obverse side and said reverse side surface of said base paper by soft calendaring treatment;
treating said obverse side and said reverse side surface of said base paper by corona discharge treatment at a wattage density in a range of from 15 to 150 W/m²/min; and
forming a polymer coating layer on both said obverse side and said reverse side surface of said base paper,
wherein said soft calendaring treatment is performed at a surface temperature in a range of from 200 to 350° C. for said obverse side surface of said base paper.

6. The method for manufacturing a support as defined in claim 5, wherein said polymer coating layer is formed on said obverse side surface of said base paper within one minute from said corona discharge treatment.

7. The method for manufacturing a support as defined in claim 5, wherein said polymer coating layer is formed by melt extrusion lamination.

8. The method for manufacturing a support as defined in claim 5, wherein said polymer coating layer is formed at a coating speed greater than 250 m/min with a melt extrusion coating machine.

9. An image recording medium, comprising:
base paper,
a polymer coating layer formed on both obverse side and reverse side surfaces of said base paper treated by soft calendaring treatment and subsequently corona discharge treatment at a wattage density in a range of from 15 to 150 W/m²/min;
an image forming layer formed over said polymer coating layer on at least said obverse side surface of said base paper,
wherein said obverse side surface of said base paper is calendered at a surface temperature in a range of from 200 to 350° C.

10. The support for an image recording medium as defined in claim 9, wherein said polymer coating layer contains a polyolefin resin.

11. The support for an image recording medium as defined in claim 9, wherein said polymer coating layer on at least said obverse side surface of said base paper contains more than 50% by mass of a polyethylene resin having an MRF in a range of from 10 to 20 and a wattage density in a range of 0.195 to 0.930.

12. The support for an image recording medium as defined in claim 9, wherein said polymer coating layer is formed at a coating speed greater than 250 m/min with a melt extrusion coating machine.
